(19) United States
(12) Patent Application Publication
(10) Pub. No.: US 2026/0358598 A1
(43) Pub. Date: Nov. 12, 2026

(54) LENS OPTICAL SYSTEM AND IMAGING APPARATUS

(71) Applicants: SONY GROUP CORPORATION, TOKYO (JP); SONY SEMICONDUCTOR SOLUTIONS CORPORATION, KANAGAWA (JP)

(72) Inventors: KAZUKI SOMEYA, TOKYO (JP); YOSUKE NARITA, TOKYO (JP); KATSUJI KIMURA, KANAGAWA (JP)

(21) Appl. No.: 19/139,866

(22) PCT Filed: Dec. 4, 2023
(86) PCT No.: PCT/JP2023/043217

§ 371 Date: Jun. 16, 2025

(30) Foreign Application Priority Data
Dec. 23, 2022 (JP) 2022-207205

(51) Int. Cl. G02B 13/00; G02B 9/62

(52) U.S. Cl. CPC G02B 13/0045; G02B 9/62

(57) ABSTRACT

The present technology relates to a lens optical system and an imaging apparatus capable of realizing high optical performance corresponding to a large-sized and high-pixel solid-state image pickup element in the lens optical system. The lens optical system includes first and second lenses having a meniscus shape convex toward an object side, a third lens, fourth and fifth lenses having a meniscus shape convex toward an image side, and sixth and seventh lenses having a meniscus shape convex toward the object side in order from the object side toward the image side. The first lens and the fourth lens have positive refractive powers near an optical axis, the second lens and the seventh lens have negative refractive powers near the optical axis, and the third lens, the fifth lens, and the sixth lens have refractive powers near the optical axis. Among air intervals on the optical axis between facing surfaces of each pair including two adjacent lenses of the first to seventh lenses, the interval between the pair including the fourth lens and the fifth lens is the longest. The present technology can be applied to, for example, the imaging apparatus and the like.

### TECHNICAL FIELD

The present technology relates to a lens optical system and an imaging apparatus, and particularly, to a lens optical system and an imaging apparatus capable of realizing high optical performance corresponding to a large-sized and high-pixel solid-state image pickup element in the lens optical system.

### BACKGROUND ART

As an imaging apparatus including a solid-state image pickup element such as a charge-coupled device (CCD) sensor or a complementary metal oxide semiconductor (CMOS) image sensor, a small-sized camera mounted on a mobile phone or a smartphone, a digital still camera, or the like has been known. In such an imaging apparatus, a smaller-sized lens optical system having a short optical overall length is required in order to further decrease a size.

In recent years, the number of pixels of the solid-state image pickup element in the small-sized camera has been increased, and a model including a high-pixel solid-state image pickup element equivalent to the digital still camera has been widely used. Therefore, the lens optical system of the small-sized camera is required to have high optical performance corresponding to the high-pixel solid-state image pickup element. Furthermore, in order to achieve higher definition imaging while preventing image quality degradation due to noise in dark place imaging, the size of the solid-state image pickup element is increasing.

However, in a lens optical system including six lenses, when the size of the solid-state image pickup element increases, a refractive power of each lens increases, and it becomes difficult to correct various aberrations. Accordingly, seven or more lenses are required to realize a small-sized and high optical performance lens optical system corresponding to the large-sized solid-state image pickup element.

As a lens optical system including seven lenses, for example, a lens optical system including a first lens having a positive refractive power, a second lens having a positive refractive power, a third lens having a negative refractive power, a fourth lens having a positive refractive power, a fifth lens having a positive refractive power, a sixth lens, and a seventh lens having a negative refractive power in order from an object side to an image side has been devised (see, for example, Patent Document 1).

### CITATION LIST

### Patent Document

Patent Document 1: Japanese Patent Application Laid-Open No. 2022-034768

### SUMMARY OF THE INVENTION

### Problems to be Solved by the Invention

However, in the lens optical system having seven or more lenses, the high optical performance corresponding to the large-sized and high-pixel solid-state image pickup element has not yet been realized. Accordingly, there is a demand for provision of a method for realizing the high optical performance corresponding to the large-sized and high-pixel solid-state image pickup element in the lens optical system, but such a demand has not been sufficiently met.

The present technology has been made in view of such a situation, and an object thereof is to realize high optical performance corresponding to a large-sized and high-pixel solid-state image pickup element in a lens optical system.

### Solutions to Problems

A lens optical system according to a first aspect of the present technology is a lens optical system that includes, in order from an object side to an image side, a first lens having a positive refractive power near an optical axis and having a meniscus shape convex toward the object side, a second lens having a negative refractive power near the optical axis and having a meniscus shape convex toward the object side, a third lens having a refractive power near the optical axis, a fourth lens having a positive refractive power near the optical axis and having a meniscus shape convex toward the image side, a fifth lens having a refractive power near the optical axis and having a meniscus shape convex toward the image side, a sixth lens having a refractive power near the optical axis and having a meniscus shape convex toward the object side, and a seventh lens having a negative refractive power near the optical axis and having a meniscus shape convex toward the object side, in which among air intervals on an optical axis between facing surfaces of each pair including two adjacent lenses among the first lens to the seventh lens, the interval between the pair including the fourth lens and the fifth lens is the longest.

In the first aspect of the present technology, the first lens having the positive refractive power near the optical axis and having the meniscus shape convex toward the object side and the second lens having the negative refractive power near the optical axis and having the meniscus shape convex toward the object side are provided in order from the object side to the image side. Next, the third lens having the refractive power near the optical axis, the fourth lens having the positive refractive power near the optical axis and having the meniscus shape convex toward the image side, and the fifth lens having the refractive power near the optical axis and having the meniscus shape convex toward the image side are provided. Next, the sixth lens having the refractive power near the optical axis and having the meniscus shape convex toward the object side is provided. Next, the seventh lens having the negative refractive power near the optical axis and having the convex meniscus shape on the object side is provided. It is to be noted that, among the air intervals on the optical axis between the facing surfaces of each pair including two adjacent lenses among the first lens to the seventh lens, the interval of the pair including the fourth lens and the fifth lens is the longest.

An imaging apparatus according to a second aspect of the present technology is an imaging apparatus that includes a lens optical system that includes, in order from an object side to an image side, a first lens having a positive refractive power near an optical axis and having a meniscus shape convex toward the object side, a second lens having a negative refractive power near the optical axis and having a meniscus shape convex toward the object side, a third lens having a refractive power near the optical axis, a fourth lens having a positive refractive power near the optical axis and having a meniscus shape convex toward the image side, a fifth lens having a refractive power near the optical axis and having a meniscus shape convex toward the image side, a sixth lens having a refractive power near the optical axis and having a meniscus shape convex toward the object side, and a seventh lens having a negative refractive power near the optical axis and having a meniscus shape convex toward the object side, among air intervals on an optical axis between facing surfaces of each pair including two adjacent lenses among the first lens to the seventh lens, the interval between a pair including the fourth lens and the fifth lens being the longest, and an image pickup element that converts an optical image formed by the lens optical system into an electric signal.

In the second aspect of the present technology, the lens optical system and the image pickup element that converts the optical image formed by the lens optical system into the electric signal are provided. The lens optical system includes, in order from the object side to the image side, the first lens having the positive refractive power near the optical axis and having the meniscus shape convex toward the object side, and the second lens having the negative refractive power near the optical axis and having the meniscus shape convex toward the object side. Next, the third lens having the refractive power near the optical axis, the fourth lens having the positive refractive power near the optical axis and having the meniscus shape convex toward the image side, and the fifth lens having the refractive power near the optical axis and having the meniscus shape convex toward the image side are provided. Next, the sixth lens having the refractive power near the optical axis and having the meniscus shape convex toward the object side and the seventh lens having the negative refractive power near the optical axis and having the meniscus shape convex toward the object side are provided. It is to be noted that, among the air intervals on the optical axis between the facing surfaces of each pair including two adjacent lenses among the first lens to the seventh lens, the interval of the pair including the fourth lens and the fifth lens is the longest.

### BRIEF DESCRIPTION OF DRAWINGS

FIG. 1 is a sectional view illustrating a configuration example of a first embodiment of an imaging apparatus to which the present technology is applied.

FIG. 2 is a sectional view illustrating a first configuration example of a lens optical system.

FIG. 3 is a table representing lens data of a lens of FIG. 2.

FIG. 4 is a table representing aspherical data of a surface of FIG. 2.

FIG. 5 is a diagram for explaining an effect by a surface interval.

FIG. 6 is a graph representing a spherical aberration, a field curvature, and a distortion aberration in the lens optical system of FIG. 2.

FIG. 7 is a sectional view illustrating a second configuration example of the lens optical system.

FIG. 8 is a table representing lens data of a lens of FIG. 7.

FIG. 9 is a table representing aspherical data of a surface of FIG. 7.

FIG. 10 is a graph representing a spherical aberration, a field curvature, and a distortion aberration in the lens optical system of FIG. 7.

FIG. 11 is a sectional view illustrating a third configuration example of the lens optical system.

FIG. 12 is a table representing lens data of a lens of FIG. 11.

FIG. 13 Is a Table Representing Aspherical Data of a surface of FIG. 11.

FIG. 14 is a graph representing a spherical aberration, a field curvature, and a distortion aberration in the lens optical system of FIG. 11.

FIG. 15 is a sectional view illustrating a fourth configuration example of the lens optical system.

FIG. 16 is a table representing lens data of a lens of FIG. 15.

FIG. 17 is a table representing aspherical data of a surface of FIG. 15.

FIG. 18 is a graph representing a spherical aberration, a field curvature, and a distortion aberration in the lens optical system of FIG. 15.

FIG. 19 is a sectional view illustrating a fifth configuration example of the lens optical system.

FIG. 20 is a table representing lens data of a lens of FIG. 19.

FIG. 21 is a table representing aspherical data of a surface of FIG. 19.

FIG. 22 is a graph representing a spherical aberration, a field curvature, and a distortion aberration in the lens optical system of FIG. 19.

FIG. 23 is a table representing values of parameters or expressions in the lens optical system.

FIG. 24 is a block diagram illustrating a hardware configuration example of a smartphone as an electronic device to which the present technology is applied.

FIG. 25 is a diagram for explaining a usage example of the imaging apparatus.

FIG. 26 is a diagram illustrating an example of a schematic configuration of an endoscopic surgery system.

FIG. 27 is a block diagram illustrating an example of a functional configuration of a camera head and a CCU.

FIG. 28 is a block diagram illustrating an example of a schematic configuration of a vehicle control system.

FIG. 29 is an explanatory diagram illustrating an example of an installation position of an imaging section.

### MODE FOR CARRYING OUT THE INVENTION

Hereinafter, modes for carrying out the present technology (hereinafter, referred to as embodiments) will be described. It is to be noted that the description will be made in the following order.
1. One Embodiment (Imaging Apparatus)
2. Application Example to Electronic Device
3. Usage Example of Imaging Apparatus
4. Application Example to Endoscopic Surgery System
5. Application Example to Moving Body

It is to be noted that the same or similar portions are denoted by the same or similar reference signs in the drawings referred to in the following description. However, the drawings are schematic, and a relationship between a thickness and a plane dimension, a ratio of a thickness of each layer, and the like are different from an actual ratio. Furthermore, the drawings may include portions having different dimensional relationships and ratios in some cases.

Furthermore, definition of directions such as up and down and the like in the following description is merely the definition for ease of explanation, and does not limit the technical idea of the present disclosure. For example, when an object is rotated by 90° to be observed, upper and lower sides are changed as left and right sides, and, when the object is rotated by 180° to be observed, the upper and lower sides are reversed.

### 1. Embodiment

### <Configuration Example of Imaging Apparatus>

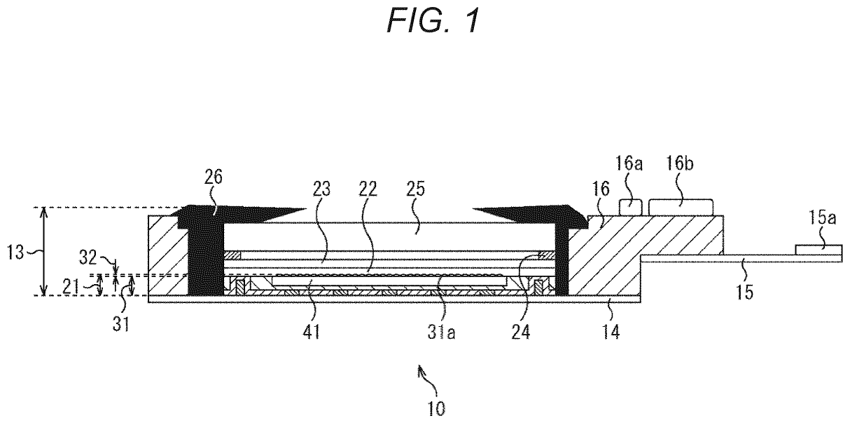

FIG. 1 is a sectional view illustrating a configuration example of an embodiment of an imaging apparatus to which the present technology is applied.

An imaging apparatus 10 in FIG. 1 includes a thin circuit board 14 on which a solid-state imaging apparatus 13 is installed, a circuit board 15, and a spacer 16.

The solid-state imaging apparatus 13 has a chip size package (CSP) structure. The CSP structure is one of structures of the solid-state imaging apparatus that realizes a large number of pixels, a decrease in size, and a low height, and is an extremely small-sized package structure realized in the same size as the single chip. The solid-state imaging apparatus 13 includes a solid-state image pickup element 21, an adhesive 22, a glass substrate 23, a black resin 24, a lens optical system 25, and a fixing agent 26.

The solid-state image pickup element 21 is a CCD sensor or a CMOS image sensor, and includes a semiconductor substrate 31 and an on-chip lens 32. A lower surface of the semiconductor substrate 31 in FIG. 1 is connected to the circuit board 14. A pixel array 41 and the like including light receiving elements corresponding to a plurality of pixels arrayed in a two-dimensional lattice shape are formed on an imaging surface 31a that is a partial region of an upper surface of the semiconductor substrate 31 in FIG. 1. The on-chip lens 32 is formed at a position corresponding to each pixel on the pixel array 41.

The adhesive 22 is a transparent adhesive provided on the upper surface in FIG. 1 including the imaging surface 31a of the solid-state image pickup element 21. The glass substrate 23 is bonded to the solid-state image pickup element 21 via the adhesive 22 for the purpose of fixing the solid-state image pickup element 21, protecting the imaging surface 31a, and the like.

The black resin 24 is formed on a surface of the glass substrate 23 opposite to a bonding surface of the adhesive 22, and has a function of a spacer. An infrared (IR) cut filter (not illustrated) of the lens optical system 25 is installed on the glass substrate 23 via the black resin 24 so as to be parallel to the glass substrate 23. Therefore, the glass substrate 23 is disposed between the lens optical system 25 and the imaging surface 31a. The black resin 24 (black mask) shields light outside the imaging surface 31a among light rays incident through the lens optical system 25.

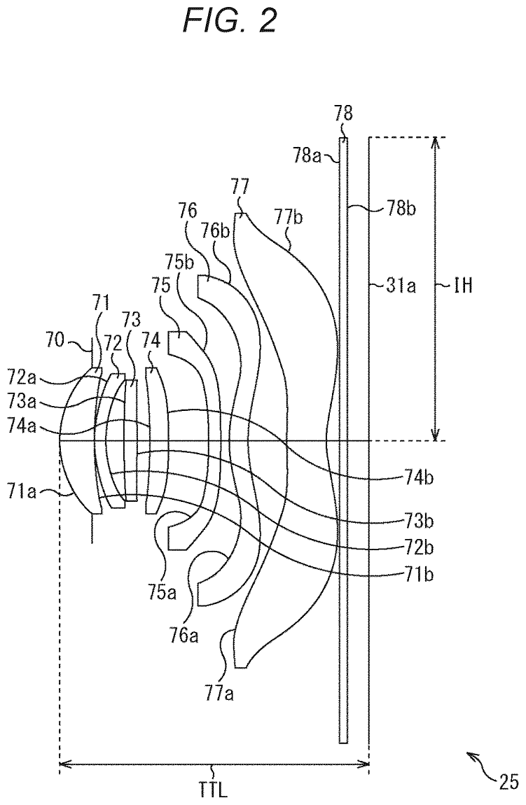

The lens optical system 25 is a lens optical system that collects light from a subject and forms an optical image on the imaging surface 31a. A configuration of the lens optical system 25 will be described in detail with reference to FIGS. 2, 7, 11, 15, and 19 as described later.

The fixing agent 26 is applied to side surfaces of the solid-state image pickup element 21, the adhesive 22, the glass substrate 23, the black resin 24, and the lens optical system 25, and a periphery of a surface (upper surface in FIG. 1) of the lens optical system 25 on an object side (incident side of light). The fixing agent 26 fixes the solid-state image pickup element 21, the adhesive 22, the glass substrate 23, the black resin 24, and the lens optical system 25. The fixing agent 26 can reduce light that is incident from the side surface of the solid-state imaging apparatus 13 and is refracted or reflected. Furthermore, the fixing agent 26 can shield light incident on the solid-state imaging apparatus 13 from an outside of a region corresponding to the imaging surface 31a.

Light from the subject is incident on the imaging surface 31a via the lens optical system 25, the glass substrate 23, the adhesive 22, and the on-chip lens 32, and therefore, the optical image is formed on the imaging surface 31a. Each light receiving element of the pixel array 41 performs imaging by converting the optical image into an electric signal.

As described above, since the lens optical system 25 is included in the CSP structure of the solid-state imaging apparatus 13, the size of the imaging apparatus 10 can be decreased as compared with a case where the lens optical system 25 is provided separately.

The circuit board 14 is a circuit board that is connected to the lower surface of the semiconductor substrate 31 in FIG. 1 and outputs a camera signal corresponding to the electric signal generated by each light receiving element to the spacer 16.

The circuit board 15 is a circuit board for outputting the camera signal output from the circuit board 14 via the spacer 16 to the outside, and electronic components and the like are implemented on the circuit board 15. The circuit board 15 has a connector 15a for connection with an external apparatus, and outputs the camera signal to the external apparatus.

The spacer 16 is a circuit built-in spacer for fixing an actuator (not illustrated) that drives the lens optical system 25 and the circuit board 15. Semiconductor components 16a and 16b and the like are implemented on the spacer 16. The semiconductor components 16a and 16b are a capacitor, a semiconductor component constituting a large scale integration (LSI) that controls the actuator (not illustrated) that drives the lens optical system 25, and the like. The spacer 16 outputs the camera signal output from the circuit board 14 to the circuit board 15.

### <First Configuration Example of Lens Optical System>

FIG. 2 is a sectional view illustrating a first configuration example of the lens optical system 25.

As illustrated in FIG. 2, the lens optical system 25 includes an aperture stop 70, a lens 71 (first lens), a lens 72 (second lens), a lens 73 (third lens), a lens 74 (fourth lens), a lens 75 (fifth lens), a lens 76 (sixth lens), a lens 77 (seventh lens), and an IR cut filter 78 in order from the object side to an image side (emission side of light).

The aperture stop 70 limits light incident on the lens optical system 25.

The lens 71 has a surface 71a on the object side (left side in FIG. 2) and a surface 71b on the image side (right side in FIG. 2). The lens 71 has a positive refractive power near an optical axis and has a meniscus shape convex toward the object side. The lens 72 has a surface 72a on the object side and a surface 72b on the image side. The lens 72 has a negative refractive power near an optical axis and has a meniscus shape convex toward the object side. The lenses 71 and 72 have the above-described configurations, and thus, it is possible to shorten a total length TTL of the lens optical system 25, which is a distance from the surface 71a to the imaging surface 31a, while favorably correcting a spherical aberration and a chromatic aberration.

The lens 73 has a surface 73a on the object side and a surface 73b on the image side. The lens 73 has a positive refractive power near an optical axis and has a meniscus shape convex toward the object side. The lens 73 functions as, for example, a relay lens, and suitably corrects an incident angle of a light ray. In order to cause the lens 73 to function as the relay lens, a shape of the lens 73 is desirably determined such that a distance from an optical axis of a light ray incident on the lens 73 is shorter than a distance from an optical axis of a light ray emitted from the lens 73. The lens 74 has a surface 74a on the object side and a surface 74b on the image side. The lens 74 has a positive refractive power near an optical axis and has a meniscus shape convex toward the image side.

As described above, the lens 73 has a refractive power near an optical axis, and the lens 74 has a positive refractive power near an optical axis and has a meniscus shape convex toward the image side. Accordingly, a coma aberration and an astigmatism can be favorably corrected. Furthermore, it is possible to suitably correct an emission angle of the light ray, shorten the total length TTL, and suppress an angle formed by a principal light ray of the light incident on the imaging surface 31a and the imaging surface 31a.

The lens 75 has a surface 75a on the object side and a surface 75b on the image side. The lens 75 has a negative refractive power near an optical axis and has a meniscus shape convex toward the image side. The lens 75 suitably corrects a coma aberration and a field curvature aberration in a peripheral portion while correcting a light ray near an optical axis. In order to suitably correct a path of a light ray reaching a periphery of the imaging surface 31a, the peripheral portion of the surface 75a is desirably closer to the object side than a vertex (center point).

The lens 76 has a surface 76a on the object side and a surface 76b on the image side. The lens 76 has a positive refractive power near an optical axis and has a meniscus shape convex toward the object side. The lens 77 has a surface 77a on the object side and a surface 77b on the image side. The lens 77 has a negative refractive power near an optical axis and has a meniscus shape convex toward the object side. The lenses 76 and 77 suitably correct a coma aberration, a spherical aberration, a field curvature aberration, and a lateral chromatic aberration in a peripheral portion while correcting a light ray near an optical axis. In order to suitably correct a path of a light ray reaching a periphery of the imaging surface 31a, the lenses 76 and 77 desirably have one or more inflection points.

As described above, the lens 75 has a refractive power near an optical axis and has a meniscus shape convex toward the image side, and the lenses 76 and 77 have a refractive power near the optical axis and have a meniscus shape convex toward the object side. Accordingly, the field curvature aberration and a distortion aberration can be suitably corrected while suitably correcting a marginal ray near an optical axis. Furthermore, it is possible to suitably correct an angle formed by the light ray reaching the periphery of the imaging surface 31a and the imaging surface 31a, and to suppress a decrease in the amount of received light in the solid-state image pickup element 21.

The IR cut filter 78 transmits light other than infrared light among light rays incident from the surface 78a on the object side and emits the light from the surface 78b on the image side. It is to be noted that the IR cut filter 78 may not be provided.

The light incident on the lens optical system 25 from the subject (object) is emitted via the surfaces 71a, 71b, 72a, 72b, 73a, 73b, 74a, 74b, 75a, 75b, 76a, 76b, 77a, 77b, 78a, and 78b. The light emitted from the lens optical system 25 in this manner is condensed on the imaging surface 31a via the glass substrate 23, the adhesive 22, and the on-chip lens 32.

In FIG. 2, only the imaging surface 31a is illustrated in order to simplify the drawing, but actually, the glass substrate 23, the adhesive 22, and the on-chip lens 32 are present between the lens optical system 25 and the imaging surface 31a. The same applies to FIGS. 2, 7, 11, 15, and 19 as described later.

### <First Example of Lens Data of Each Lens>

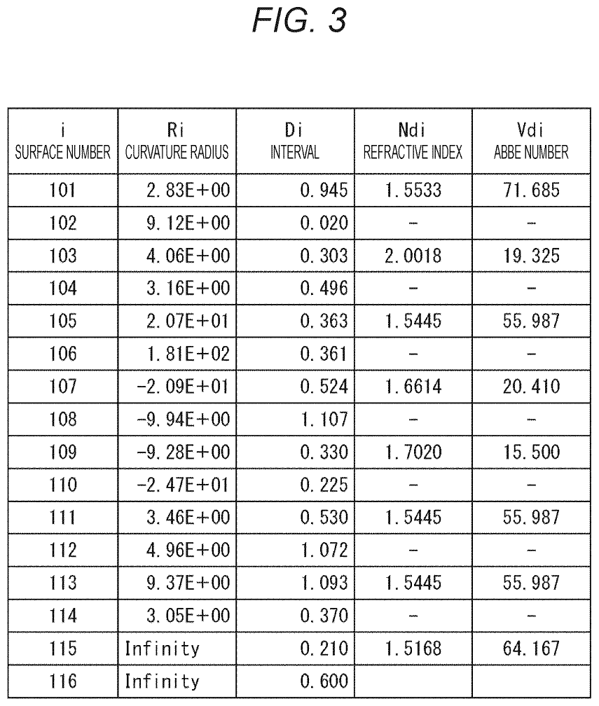

FIG. 3 is a table representing the lens data of the lenses 71 to 77.

Rows in the table of FIG. 3 correspond to the surfaces 71a to 78a and the surfaces 71b to 78b, respectively. Columns correspond to a surface number i, a curvature radius Ri, a surface interval Di which is an interval on an optical axis with a closest surface on the image side or the imaging surface 31a, a refractive index Ndi with respect to a d line (wavelength 587.6 nm), and an Abbe number Vdi with respect to the d line in order from a left side.

The surface number is a number given to each surface of the lens optical system 25. In the present specification, it is assumed that surface numbers having 101 to 116 are sequentially assigned to the surfaces 71a, 71b, 72a, 72b, 73a, 73b, 74a, 74b, 75a, 75b, 76a, 76b, 77a, 77b, 78a, and 78b.

As illustrated in FIG. 3, a curvature radius R101 of the surface 71a of which the surface number i is 101 is 2.83, a surface interval D101, which is an interval on the optical axis with the closest surface 71b on the image side with respect to the surface 71a, is 0.945, and a refractive index Nd101 is 1.5533. An Abbe number Vd101 of the surface 71a, that is, an Abbe number V101 of the lens 71 is 71.685. A curvature radius R102 of the surface 71b of which the surface number i is 102 is 9.12, and a surface interval D102, which is an air interval on the optical axis with the closest surface 72a on the image side with respect to the surface 71b, is 0.020.

A curvature radius R103 of the surface 72a of which the surface number i is 103 is 4.06, a surface interval D103, which is an interval on the optical axis with the closest surface 72b on the image side with respect to the surface 72a, is 0.303, and a refractive index Nd103 is 2.0018. An Abbe number Vd103 of the surface 72a, that is, an Abbe number V102 of the lens 72 is 19.325. A curvature radius R104 of the surface 72b of which the surface number i is 104 is 3.16, and a surface interval D104, which is an air interval on the optical axis with the closest surface 73a on the image side with respect to the surface 72b, is 0.496.

A curvature radius R105 of the surface 73a of which the surface number i is 105 is 2.07 ×10, a surface interval D105, which is an interval on the optical axis with the closest surface 73b on the image side with respect to the surface 73a, is 0.363, and a refractive index Nd105 is 1.5445. An Abbe number Vd105 of the surface 73a, that is, an Abbe number V103 of the lens 73 is 55.987. A curvature radius R106 of the surface 73b of which the surface number i is 106 is 1.81 ×10², and a surface interval D106, which is an air interval on the optical axis with the closest surface 74a on the image side with respect to the surface 73b, is 0.361.

A curvature radius R107 of the surface 74a of which the surface number i is 107 is −2.09 ×10, a surface interval D107, which is an interval on the optical axis with the closest surface 74b on the image side with respect to the surface 74a, is 0.524, and a refractive index Nd107 is 1.6614. An Abbe number Vd107 of the surface 74a, that is, an Abbe number V104 of the lens 74 is 20.410. A curvature radius R108 of the surface 74b of which the surface number i is 108is −9.94 , and a surface interval D108, which is an air interval on the optical axis with the closest surface 75a on the image side with respect to the surface 74b, is 1.107.

A curvature radius R109 of the surface 75a of which the surface number i is 109is −9.28 , a surface interval D109, which is an interval on the optical axis with the closest surface 75b on the image side with respect to the surface 75a, is 0.330, and a refractive index Nd109 is 1.7020. An Abbe number Vd109 of the surface 75a, that is, an Abbe number V105 of the lens 75 is 15.500. A curvature radius R110 of the surface 75b of which the surface number i is 110 is −2.47 ×10, and a surface interval D110, which is an air interval on the optical axis with the closest surface 76a on the image side with respect to the surface 75b, is 0.225.

A curvature radius R111 of the surface 76a of which the surface number i is 111 is 3.46, a surface interval D111, which is an interval on the optical axis with the closest surface 76b on the image side with respect to the surface 76a, is 0.530, and a refractive index Nd111 is 1.5445. An Abbe number Vd111 of the surface 76a, that is, an Abbe number V106 of the lens 76 is 55.987. A curvature radius R112 of the surface 76b of which the surface number i is 112 is 4.96, and a surface interval D112, which is an air interval on the optical axis with the closest surface 77a on the image side with respect to the surface 76b, is 1.072.

A curvature radius R113 of the surface 77a of which the surface number i is 113 is 9.37, a surface interval D113, which is an interval on the optical axis with the closest surface 77b on the image side with respect to the surface 77a, is 1.093, and a refractive index Nd113 is 1.5445. An Abbe number Vd113 of the surface 77a, that is, an Abbe number V107 of the lens 77 is 55.987. A curvature radius R114 of the surface 77b of which the surface number i is 114 is 3.05, and a surface interval D114, which is an air interval on the optical axis with the closest surface 78a on the image side with respect to the surface 77b, is 0.370.

A curvature radius R115 of the surface 78a of which the surface number i is 115 is infinite, a surface interval D115, which is an interval on the optical axis with the closest surface 78b on the image side with respect to the surface 78a, is 0.210, and a refractive index Nd115 is 1.5168. An Abbe number Vd115 of the surface 78a, that is, an Abbe number V108 of the IR cut filter 78 is 64.167. A curvature radius R116 of the surface 78b of which the surface number is 116 is infinite, and a surface interval D116, which is an interval on the optical axis with the imaging surface 31a is 0.600.

As described above, among the surface intervals D102, D104, D106, D108, D110, and D112 of the facing surfaces of each pair including two adjacent lenses of the lenses 71 to 77, the surface interval D108 is the longest.

### <First Example of Aspherical Data of Each Surface>

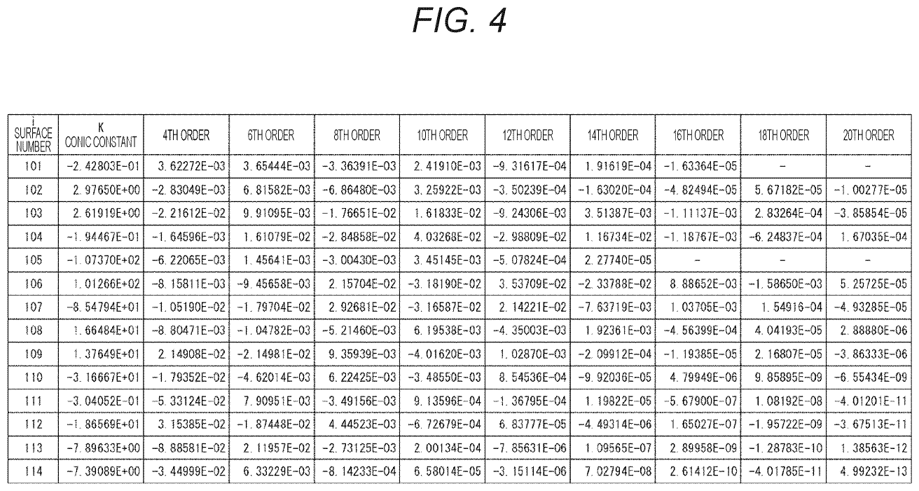

FIG. 4 is a table representing aspherical data of the surfaces 71a to 77a and the surfaces 71b to 77b.

Rows in the table of FIG. 4 correspond to the surfaces 71a to 77a and the surfaces 71b to 77b, respectively. Columns correspond to a surface number i, a conic constant K, a 4th order aspheric coefficient, a 6th order aspheric coefficient, an 8th order aspheric coefficient, a 10th order aspheric coefficient, a 12th order aspheric coefficient, a 14th order aspheric coefficient, a 16th order aspheric coefficient, a 18th order aspheric coefficient, and a 20th order aspheric coefficient in order from a left side.

As illustrated in FIG. 4, a conic constant K of the surface 71a of which the surface number i is 101 is −2.42803×10⁻¹. The 4th order aspheric coefficient, the 6th order aspheric coefficient, the 8th order aspheric coefficient, the 10th order aspheric coefficient, the 12th order aspheric coefficient, the 14th order aspheric coefficient, and the 16th order aspheric coefficient are 3.62272×10⁻³, 3.65444×10⁻³, −3.36391×10⁻³, 2.41910×10⁻³, −9.31617×10⁻⁴, 1.91619×10⁻⁴, and −1.63364×10⁻⁵, respectively.

A conic constant K of the surface 71b of which the surface number i is 102 is 2.97650. The 4th order aspheric coefficient, the 6th order aspheric coefficient, the 8th order aspheric coefficient, the 10th order aspheric coefficient, and the 12th order aspheric coefficient are −2.83049×10⁻³, 6.81582×10⁻³, −6.86480×10⁻³, 3.25922×10⁻³, and −3.50239×10⁻⁴, respectively. The 14th order aspheric coefficient, the 16th order aspheric coefficient, the 18th order aspheric coefficient, and the 20th order aspheric coefficient are −1.63020×10⁻⁴, −4.82494×10⁻⁵, 5.67182×10⁻⁵, and −1.00277×10⁻⁵, respectively.

A conic constant K of the surface 72a of which the surface number i is 103 is 2.61919. The 4th order aspheric coefficient, the 6th order aspheric coefficient, the 8th order aspheric coefficient, the 10th order aspheric coefficient, and the 12th order aspheric coefficient are −2.21612×10⁻², 9.91095×10⁻³, −1.76651×10⁻², 1.61833×10⁻², and −9.24306×10⁻³, respectively. The 14th order aspheric coefficient, the 16th order aspheric coefficient, the 18th order aspheric coefficient, and the 20th order aspheric coefficient are 3.51387×10⁻³, −1.11137×10⁻³, 2.83264×10⁻⁴, and −3.85854×10⁻⁵, respectively.

A conic constant K of the surface 72b of which the surface number i is 104 is −1.94467×10⁻¹. The 4th order aspheric coefficient, the 6th order aspheric coefficient, the 8th order aspheric coefficient, the 10th order aspheric coefficient, and the 12th order aspheric coefficient are −1.64596×10⁻³, 1.61079×10⁻², −2.84858×10⁻², 4.03268×10⁻², and −2.98809×10⁻², respectively. The 14th order aspheric coefficient, the 16th order aspheric coefficient, the 18th order aspheric coefficient, and the 20th order aspheric coefficient are 1.16734×10⁻², −1.18767×10⁻³, 6.24837×10⁻⁴, and 1.67035×10⁻⁴, respectively.

A conic constant K of the surface 73a of which the surface number i is 105 is −1.07370×10². The 4th order aspheric coefficient, the 6th order aspheric coefficient, the 8th order aspheric coefficient, the 10th order aspheric coefficient, the 12th order aspheric coefficient, and the 14th order aspheric coefficient are −6.22065×10⁻³, 1.45641×10⁻³, −3.00430×10⁻³, 3.45145×10⁻³, −5.07824×10⁻⁴, and 2.27740×10⁻⁵, respectively.

A conic constant K of the surface 73b of which the surface number i is 106 is 1.01266×10². The 4th order aspheric coefficient, the 6th order aspheric coefficient, the 8th order aspheric coefficient, the 10th order aspheric coefficient, and the 12th order aspheric coefficient are −8.15811×10⁻³,-9.45658 ×10⁻³, 2.15704×10⁻²,-3.18190 ×10⁻², and 3.53709×10⁻², respectively. The 14th order aspheric coefficient, the 16th order aspheric coefficient, the 18th order aspheric coefficient, and the 20th order aspheric coefficient are- 2.33788×10⁻², 8.88652×10⁻³, 1.58650×10⁻³, and 5.25725×10⁻⁵, respectively.

A conic constant K of the surface 74a of which the surface number i is 107 is −8.54794×10. The 4th order aspheric coefficient, the 6th order aspheric coefficient, the 8th order aspheric coefficient, the 10th order aspheric coefficient, and the 12th order aspheric coefficient are −1.05190×10⁻², −1.79704×10⁻², 2.92681×10⁻², −3.16587×10⁻², and 2.14221×10⁻², respectively. The 14th order aspheric coefficient, the 16th order aspheric coefficient, the 18th order aspheric coefficient, and the 20th order aspheric coefficient are −7.63719×10⁻³, 1.03705×10⁻³, 1.54916×10⁻⁴, and −4.93285×10⁻⁵, respectively.

A conic constant K of the surface 74b of which the surface number i is 108 is 1.66484×10. The 4th order aspheric coefficient, the 6th order aspheric coefficient, the 8th order aspheric coefficient, the 10th order aspheric coefficient, and the 12th order aspheric coefficient are −8.80471×10⁻³, −1.04782×10⁻³, −5.21460×10⁻³, 6.19538×10⁻³, and −4.35003×10⁻³, respectively. The 14th order aspheric coefficient, the 16th order aspheric coefficient, the 18th order aspheric coefficient, and the 20th order aspheric coefficient are 1.92361×10⁻³, −4.56399×10⁻⁴, 4.04193×10⁻⁵, and 2.88880×10⁻⁶, respectively.

A conic constant K of the surface 75a of which the surface number i is 109 is 1.37649×10. The 4th order aspheric coefficient, the 6th order aspheric coefficient, the 8th order aspheric coefficient, the 10th order aspheric coefficient, and the 12th order aspheric coefficient are 2.14908×10⁻², −2.14981×10⁻², 9.35939×10⁻³, −4.01620 ×10⁻³, and 1.02870×10⁻³, respectively. The 14th order aspheric coefficient, the 16th order aspheric coefficient, the 18th order aspheric coefficient, and the 20th order aspheric coefficient are −2.09912×10⁻⁴, −1.19385×10⁻⁵, 2.16807×10⁻⁵, and −3.86333×10⁻⁶, respectively.

A conic constant K of the surface 75b of which the surface number i is 110 is −3.16667×10. The 4th order aspheric coefficient, the 6th order aspheric coefficient, the 8th order aspheric coefficient, the 10th order aspheric coefficient, and the 12th order aspheric coefficient are −1.79352×10⁻², −4.62014×10⁻³, 6.22425×10⁻³, −3.48550×10⁻³, and 8.54536×10⁻⁴, respectively. The 14th order aspheric coefficient, the 16th order aspheric coefficient, the 18th order aspheric coefficient, and the 20th order aspheric coefficient are −9.92036×10⁻⁵, 4.79949×10⁻⁶, 9.85895×10⁻⁹, and −6.55434×10⁻⁹, respectively.

A conic constant K of the surface 76a of which the surface number i is 111 is −3.04052×10⁻¹. The 4th order aspheric coefficient, the 6th order aspheric coefficient, the 8th order aspheric coefficient, the 10th order aspheric coefficient, and the 12th order aspheric coefficient are −5.33124×10⁻², 7.90951×10⁻³, −3.49156 ×10⁻³, 9.13596×10⁻⁴, and −1.36795×10⁻⁴, respectively. The 14th order aspheric coefficient, the 16th order aspheric coefficient, the 18th order aspheric coefficient, and the 20th order aspheric coefficient are 1.19822×10⁻⁵, −5.67900×10⁻⁷, 1.08192×10⁻⁸, and −4.01201×10⁻¹¹, respectively.

A conic constant K of the surface 75b of which the surface number i is 112 is −1.86569×10. The 4th order aspheric coefficient, the 6th order aspheric coefficient, the 8th order aspheric coefficient, the 10th order aspheric coefficient, and the 12th order aspheric coefficient are 3.15385×10⁻², −1.87448×10⁻², 4.44523×10⁻³, −6.72679×10⁻⁴, and 6.83777×10⁻⁵, respectively. The 14th order aspheric coefficient, the 16th order aspheric coefficient, the 18th order aspheric coefficient, and the 20th order aspheric coefficient are −4.49314×10⁻⁶, 1.65027×10⁻⁷, −1.95722×10⁻⁹, and −3.67513×10⁻¹¹, respectively.

A conic constant K of the surface 77a of which the surface number i is 113 is −7.89633 . The 4th order aspheric coefficient, the 6th order aspheric coefficient, the 8th order aspheric coefficient, the 10th order aspheric coefficient, and the 12th order aspheric coefficient are −8.88581×10⁻², 2.11957×10⁻², −2.73125×10⁻³, 2.00134×10⁻⁴, and −7.85631×10⁻⁶, respectively. The 14th order aspheric coefficient, the 16th order aspheric coefficient, the 18th order aspheric coefficient, and the 20th order aspheric coefficient are 1.09565×10⁻⁷, 2.89958×10⁻⁹, −1.28783×10⁻¹⁰, and 1.38563×10⁻¹², respectively.

A conic constant K of the surface 77b of which the surface number i is 114is −7.39089 . The 4th order aspheric coefficient, the 6th order aspheric coefficient, the 8th order aspheric coefficient, the 10th order aspheric coefficient, and the 12th order aspheric coefficient are −3.44999×10⁻², 6.33229×10⁻³, −8.14233×10⁻⁴, 6.58014×10⁻⁵, and −3.15114×10⁻⁶, respectively. The 14th order aspheric coefficient, the 16th order aspheric coefficient, the 18th order aspheric coefficient, and the 20th order aspheric coefficient are 7.02794×10⁻⁸, 2.614142×10⁻¹⁰, −4.01785×10⁻¹¹, and 4.99232×10⁻¹³, respectively.

### <Effect of Surface Interval>

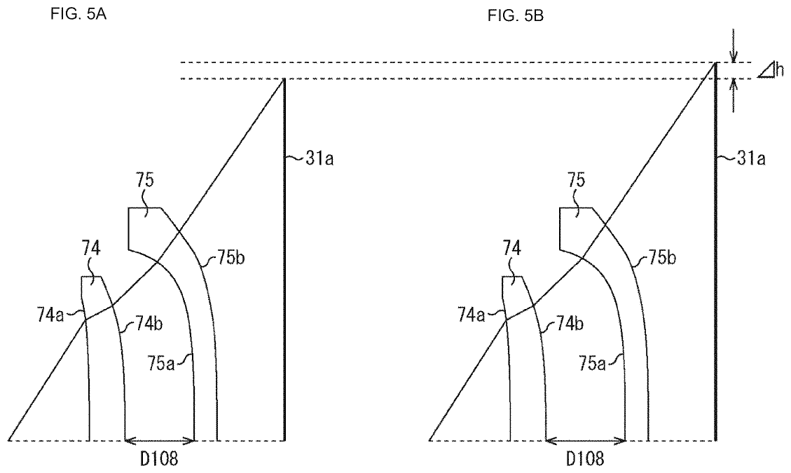

FIG. 5 is a diagram for explaining an effect of the surface interval D108 between the surface 74b and the surface 75a.

It is to be noted that, in FIG. 5, the illustration of the lens 76, the lens 77, and the IR cut filter 78 between the lens 75 and the imaging surface 31a is omitted in order to simplify the drawing.

In a case where the surface interval D108 is long as illustrated in B of FIG. 5 as compared with a case where the surface interval D108 is short as illustrated in A of FIG. 5, a light ray reaching a high image height of the imaging surface 31a can be spread in a direction away from the optical axis by Δh.

Therefore, the lens optical system 25 is designed such that the surface interval D108 is the longest among the surface intervals D102, D104, D106, D108, D110, and D112 between the facing surfaces of each pair including two adjacent lenses among the lenses 71 to 77. Therefore, a light ray reaching the high image height of the imaging surface 31a can be separated. As a result, even in a case where the size of the solid-state image pickup element 21 increases, a coma aberration, a field curvature aberration, and a distortion aberration on the high image height side can be favorably corrected.

At this time, it is difficult to correct a light ray near a near axis, but the lens optical system 25 can correct the light ray near the near axis by making the shapes of the lenses 75 to 77 into the above-described shapes.

### <First Example of Spherical Aberration, Field Curvature, and Distortion Aberration>

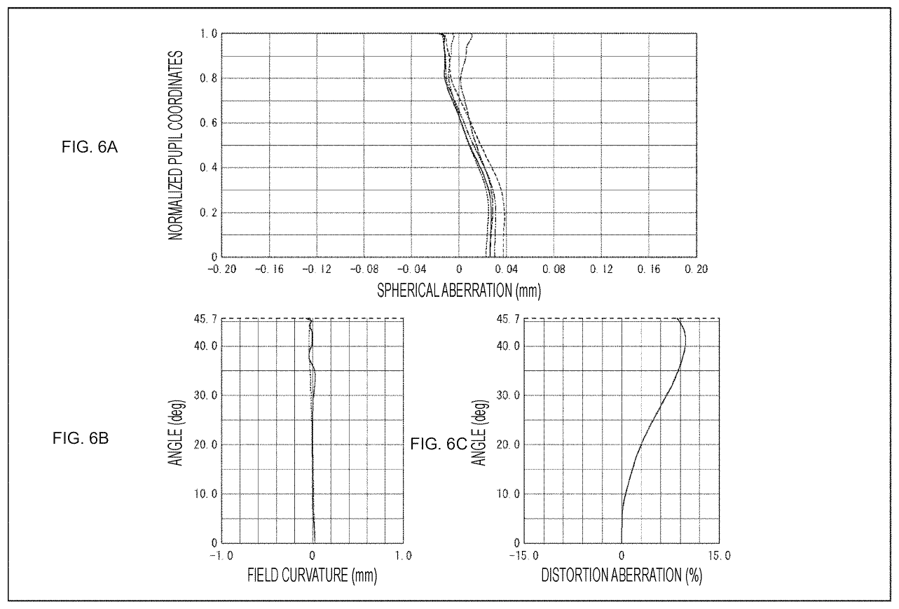

FIG. 6 is a graph representing a spherical aberration, a field curvature, and a distortion aberration which occur in the lens optical system 25 of FIG. 2.

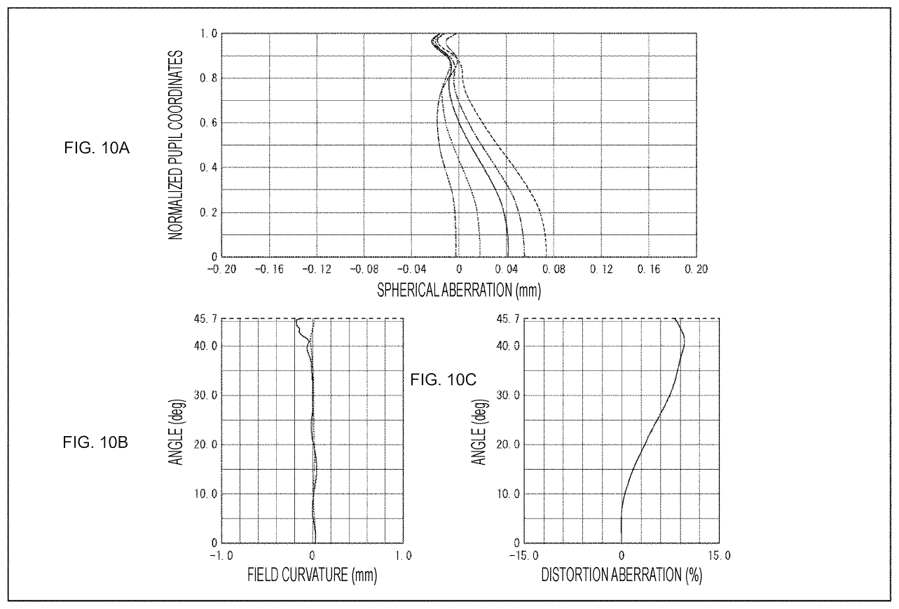

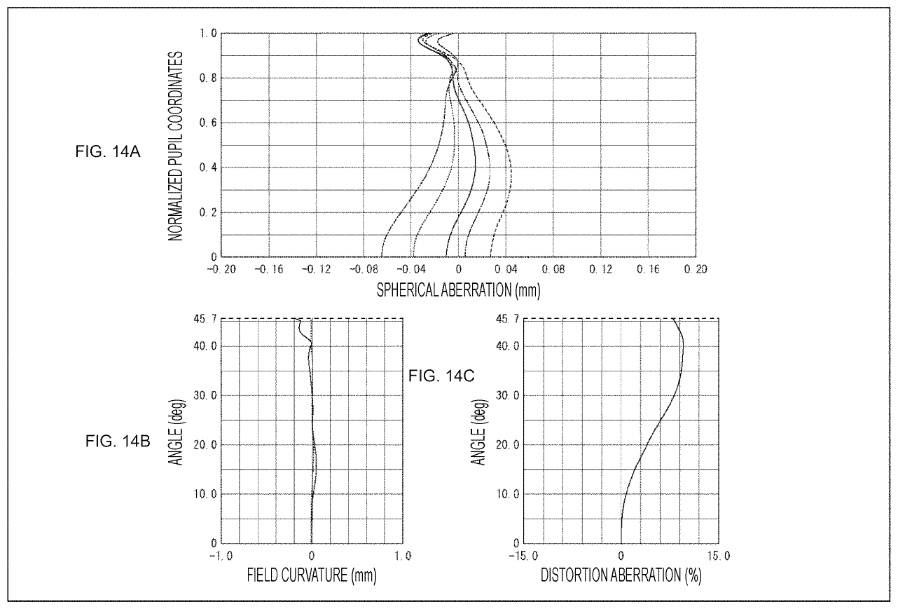

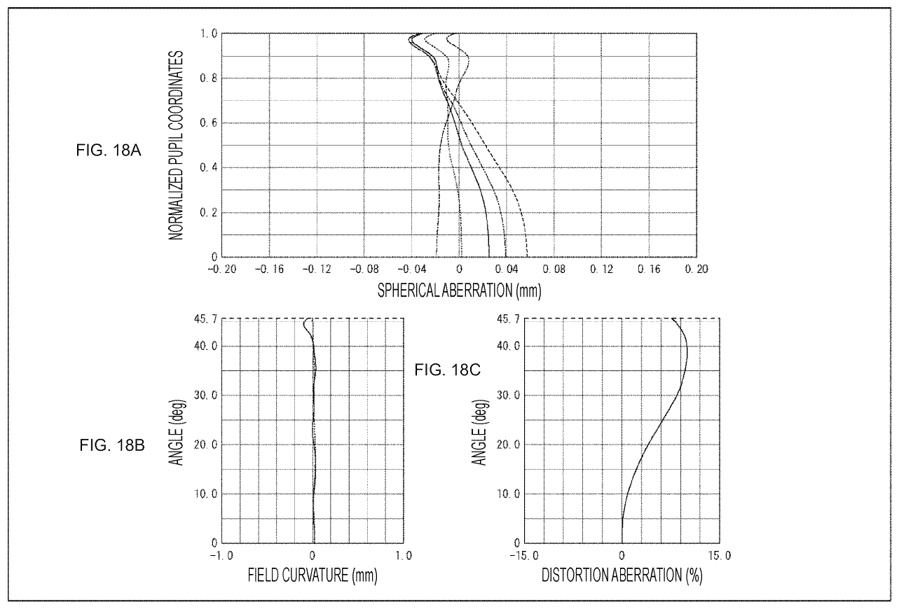

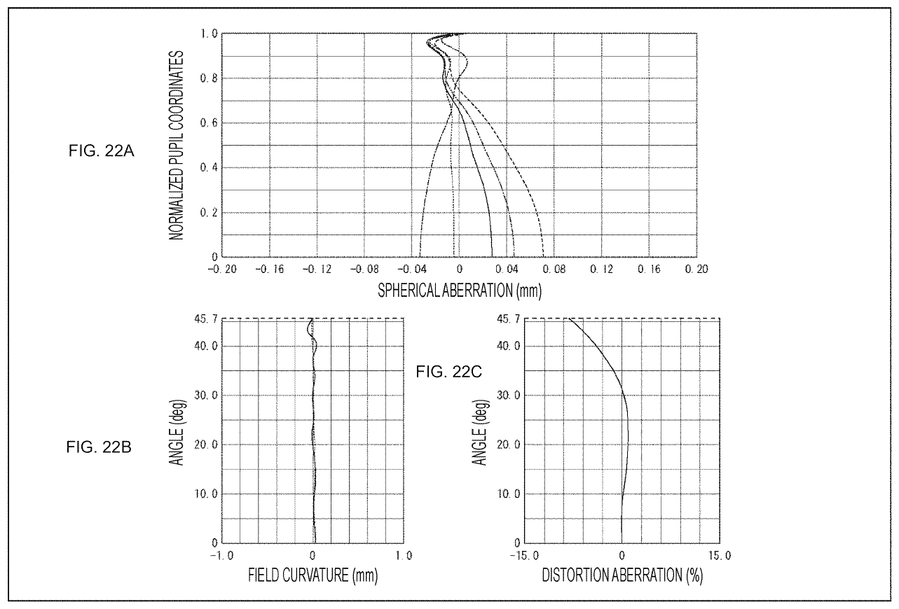

A of FIG. 6 is a graph representing a spherical aberration in a longitudinal direction for every wavelength of light rays having wavelengths of 443.58 nm, 486.13 nm, 546.07 nm, 587.56 nm, and 656.27 nm, which occurs in the lens optical system 25 of FIG. 2. In the graph in A of FIG. 6, a horizontal axis represents a spherical aberration [mm], and a vertical axis represents normalized pupil coordinates. The same applies to A of FIG. 10, A of FIG. 14, A of FIG. 18, and A of FIG. 22 as described later.

B of FIG. 6 is a graph representing a field curvature which occurs in the lens optical system 25 of FIG. 2. In the graph of B of FIG. 6, a horizontal axis represents a field curvature [mm], and a vertical axis represents an angle [degree] corresponding to an incident position in a sagittal direction or a tangential direction of the light ray. In B of FIG. 6, a solid line represents a relationship between the incident position in the tangential direction and the field curvature, and a dotted line represents a relationship between the incident position and the field curvature in the sagittal direction. The same applies to B of FIG. 10, B of FIG. 14, B of FIG. 18, and B of FIG. 22 as described later. A difference in field curvature between the sagittal direction and the tangential direction is an astigmatism.

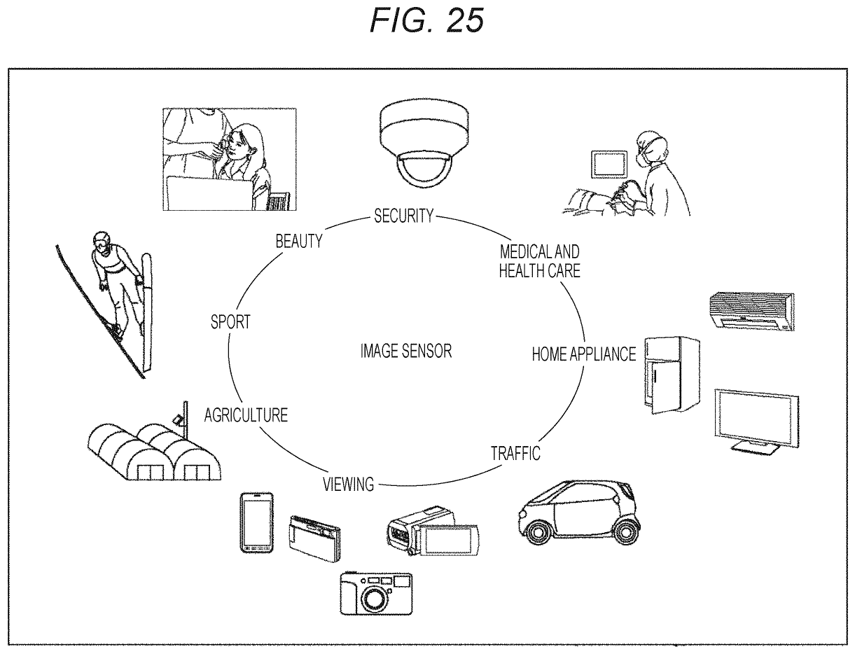

C of FIG. 6 is a graph representing a distortion aberration of the light having the wavelength of 587.56 nm, which occurs in the lens optical system 25 of FIG. 2. In the graph in C of FIG. 6, a horizontal axis represents a distortion aberration [%], and a vertical axis represents an incident angle [degree] of the light ray. The same applies to C of FIG. 10, C of FIG. 14, C of FIG. 18, and C of FIG. 25 as described later.

### <Second Configuration Example of Lens Optical System>

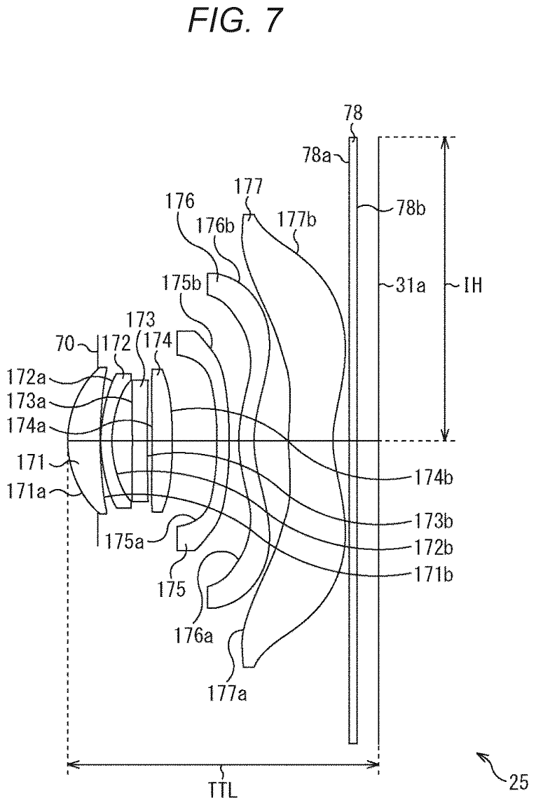

FIG. 7 is a sectional view illustrating a second configuration example of the lens optical system 25.

In the lens optical system 25 of FIG. 7, portions corresponding to those of the lens optical system 25 of FIG. 2 are denoted by the same reference signs. Accordingly, the description of the portions will be appropriately omitted, and description will be given focusing on portions different from those of the lens optical system 25 of FIG. 2. The lens optical system 25 of FIG. 7 is different from the lens optical system 25 of FIG. 2 in that the lenses 71 to 77 are replaced with lens 171 to 177, and has a configuration similar to the lens optical system 25 of FIG. 2 except for this point.

The lenses 171 to 177 are different from the lenses 71 to 77 in that lens data and aspherical data of each surface are different and the lenses 173 and 176 have negative refractive powers near an optical axis, and have configurations similar to the lenses 71 to 77 except for this point. Accordingly, hereinafter, lens data of the lenses 171 to 177 and aspherical data of surfaces 171a to 177a on the object side and surfaces 171b to 177b on the image side will be described.

### <Second Example of Lens Data of Each Lens>

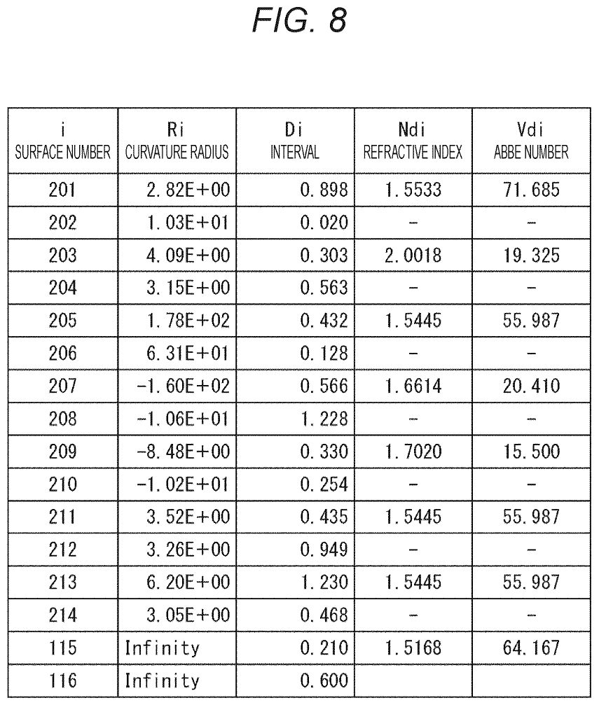

FIG. 8 is a table representing the lens data of the lenses 171 to 177.

Rows in the table of FIG. 8 correspond to the surfaces 171a to 177a, the surfaces 171b to 177b, and the surfaces 78a and 78b, respectively. Columns correspond to a surface number i, a curvature radius Ri, a surface interval Di, a refractive index Ndi with respect to a d line, and an Abbe number Vdi with respect to the d line in order from a left side.

In the present specification, it is assumed that surface numbers having 201 to 214 are sequentially assigned to the surfaces 171a, 171b, 172a, 172b, 173a, 173b, 174a, 174b, 175a, 175b, 176a, 176b, 177a, and 177b. Numerical values in the columns of the table of FIG. 8 refer to FIG. 8.

As illustrated in the table of FIG. 8, among surface intervals D202, D204, D206, D208, D210, and D212 between the facing surfaces of each pair including two adjacent lenses among the lenses 171 to 177, the surface interval D208 is the longest.

### <Second Example of Aspherical Data of Each Surface>

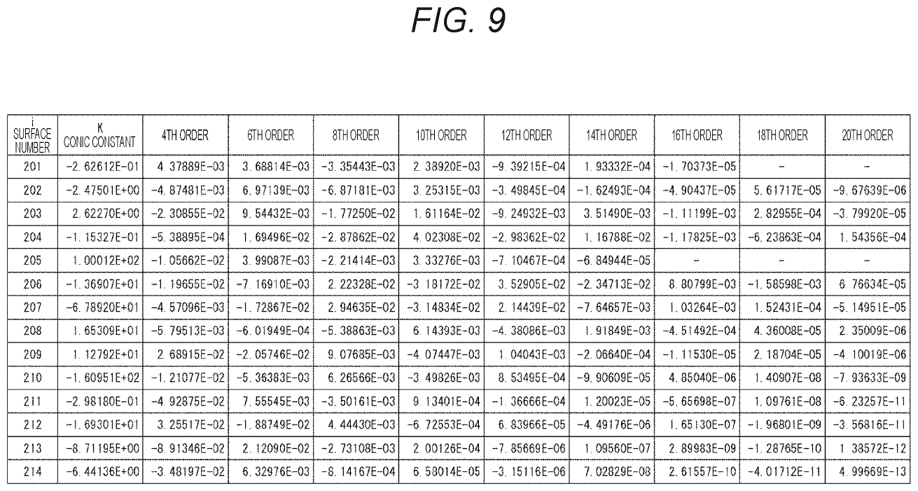

FIG. 9 is a table representing the aspherical data of the surfaces 171a to 177a and the surfaces 171b to 177b.

Rows in the table of FIG. 9 correspond to the surfaces 171a to 177a and the surfaces 171b to 177b, respectively. Columns correspond to a surface number i, a conic constant K, a 4th order aspheric coefficient, a 6th order aspheric coefficient, an 8th order aspheric coefficient, a 10th order aspheric coefficient, a 12th order aspheric coefficient, a 14th order aspheric coefficient, a 16th order aspheric coefficient, a 18th order aspheric coefficient, and a 20th order aspheric coefficient in order from a left side. Numerical values in the columns of the table of FIG. 9 refer to FIG. 9.

### <Second Example of Spherical Aberration, Field Curvature, and Distortion Aberration>

FIG. 10 is a graph representing a spherical aberration, a field curvature, and a distortion aberration which occur in the lens optical system 25 of FIG. 7.

A of FIG. 10 is a graph representing a spherical aberration in a longitudinal direction for every wavelength of light rays having wavelengths of 443.58 nm, 486.13 nm, 546.07 nm, 587.56 nm, and 656.27 nm, which occurs in the lens optical system 25 of FIG. 7. B of FIG. 10 is a graph representing a field curvature which occurs in the lens optical system 25 of FIG. 7. C of FIG. 10 is a graph representing a distortion aberration of the light having the wavelength of 587.56 nm, which occurs in the lens optical system 25 of FIG. 7.

### <Third Configuration Example of Lens Optical System>

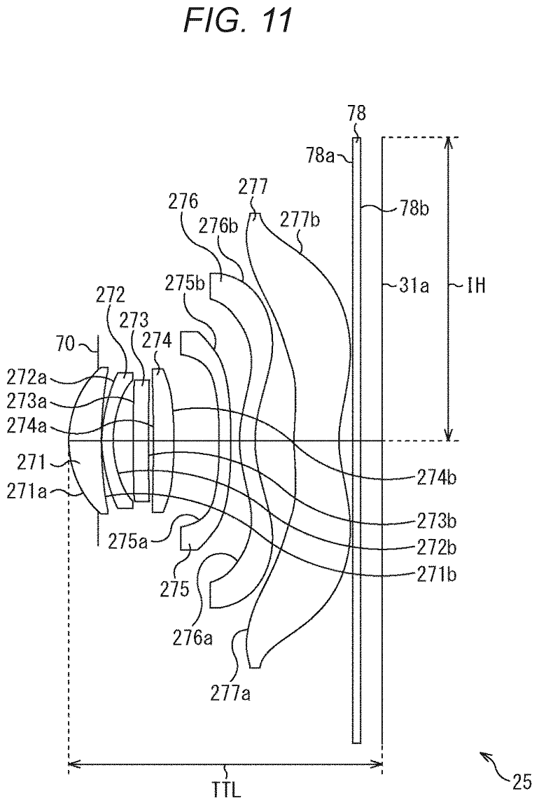

FIG. 11 is a sectional view illustrating a third configuration example of the lens optical system 25.

In the lens optical system 25 of FIG. 11, portions corresponding to those of the lens optical system 25 of FIG. 2 are denoted by the same reference signs. Accordingly, the description of the portions will be appropriately omitted, and description will be given focusing on portions different from those of the lens optical system 25 of FIG. 2. The lens optical system 25 of FIG. 11 is different from the lens optical system 25 of FIG. 2 in that the lenses 71 to 77 are replaced with lenses 271 to 277, and has a configuration similar to the lens optical system 25 of FIG. 2 except for this point.

The lenses 271 to 277 are different from the lenses 71 to 77 in that lens data and aspherical data of each surface are different, the lens 275 has a positive refractive power near an optical axis, and the lens 276 has a negative refractive power near an optical axis, and have configurations similar to the lenses 71 to 77 except for this point. Accordingly, lens data of the lenses 271 to 277 and aspherical data of surfaces 271a to 277a on the object side and surfaces 271b to 277b on the image side will be described below.

### <Third Example of Lens Data of Each Lens>

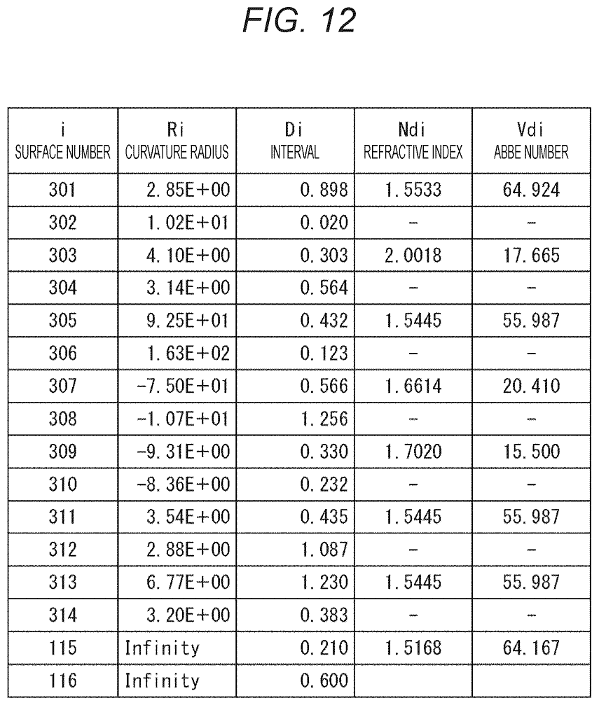

FIG. 12 is a table representing the lens data of the lenses 271 to 277.

Rows in the table of FIG. 12 correspond to the surfaces 271a to 277a, the surfaces 271b to 277b, and the surfaces 78a and 78b, respectively. Columns correspond to a surface number i, a curvature radius Ri, a surface interval Di, a refractive index Ndi with respect to a d line, and an Abbe number Vdi with respect to the d line in order from a left side.

In the present specification, it is assumed that surface numbers having 301 to 314 are sequentially assigned to the surfaces 271a, 271b, 272a, 272b, 273a, 273b, 274a, 274b, 275a, 275b, 276a, 276b, 277a, and 277b. Numerical values in the columns of the table of FIG. 12 refer to FIG. 12.

As illustrated in the table of FIG. 12, among surface intervals D302, D304, D306, D308, D310, and D312 between the facing surfaces of each pair including two adjacent lenses among the lenses 271 to 277, the surface interval D308 is the longest.

### <Third Example of Aspherical Data of Each Surface>

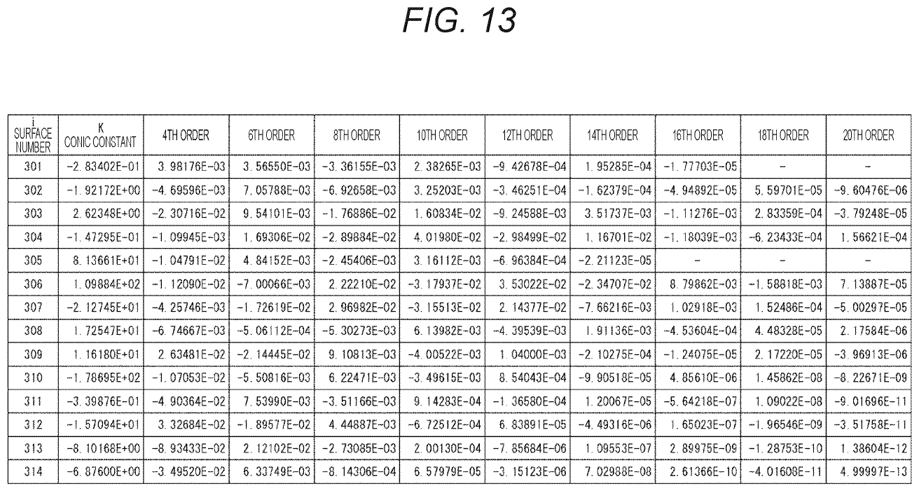

FIG. 13 is a table representing aspherical data of the surfaces 271a to 277a and the surfaces 271b to 277b.

Rows in the table of FIG. 13 correspond to the surfaces 271a to 277a and the surfaces 271b to 277b, respectively. Columns correspond to a surface number i, a conic constant K, a 4th order aspheric coefficient, a 6th order aspheric coefficient, an 8th order aspheric coefficient, a 10th order aspheric coefficient, a 12th order aspheric coefficient, a 14th order aspheric coefficient, a 16th order aspheric coefficient, a 18th order aspheric coefficient, and a 20th order aspheric coefficient in order from a left side. Numerical values in the columns of the table of FIG. 13 refer to FIG. 13.

### <Third Example of Spherical Aberration, Field Curvature, and Distortion Aberration>

FIG. 14 is a graph representing a spherical aberration, a field curvature, and a distortion aberration which occur in the lens optical system 25 of FIG. 11.

A of FIG. 14 is a graph representing a spherical aberration in a longitudinal direction for every wavelength of light rays having wavelengths of 443.58 nm, 486.13 nm, 546.07 nm, 587.56 nm, and 656.27 nm, which occurs in the lens optical system 25 of FIG. 11. B of FIG. 14 is a graph representing a field curvature which occurs in the lens optical system 25 of FIG. 11. C of FIG. 14 is a graph representing a distortion aberration of the light having the wavelength of 587.56 nm, which occurs in the lens optical system 25 of FIG. 11.

### <Fourth Configuration Example of Lens Optical System>

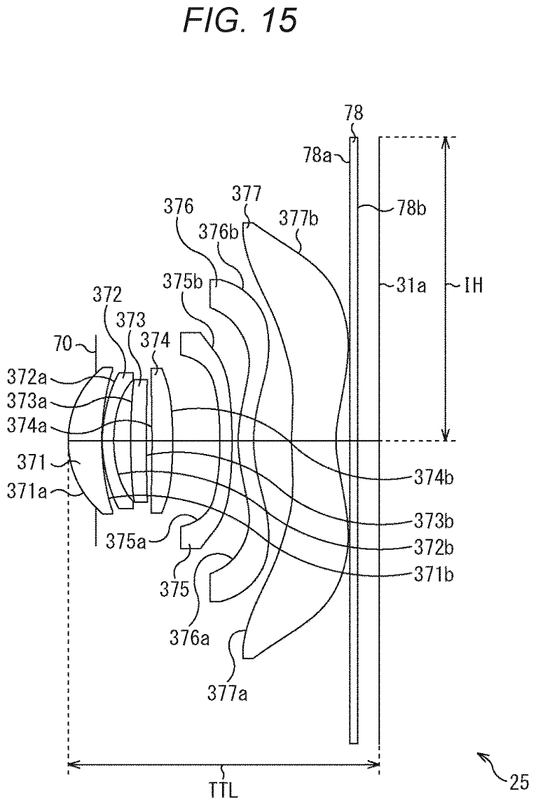

FIG. 15 is a sectional view illustrating a fourth configuration example of the lens optical system 25.

In the lens optical system 25 of FIG. 15, portions corresponding to those of the lens optical system 25 of FIG. 2 are denoted by the same reference signs. Accordingly, the description of the portions will be appropriately omitted, and description will be given focusing on portions different from those of the lens optical system 25 of FIG. 2. The lens optical system 25 of FIG. 15 is different from the lens optical system 25 of FIG. 2 in that the lenses 71 to 77 are replaced with lenses 371 to 377, and has a configuration similar to the lens optical system 25 of FIG. 2 except for this point.

The lenses 371 to 377 are different from the lenses 71 to 77 in that lens data and aspherical data of each surface are different and the lens 376 has a negative refractive power near the optical axis, and have configurations similar to the lenses 71 to 77 except for this point. Accordingly, hereinafter, lens data of the lenses 371 to 377 and aspherical data of surfaces 371a to 377a on the object side and surfaces 371b to 377b on the image side will be described below.

### <Fourth Example of Lens Data of Each Lens>

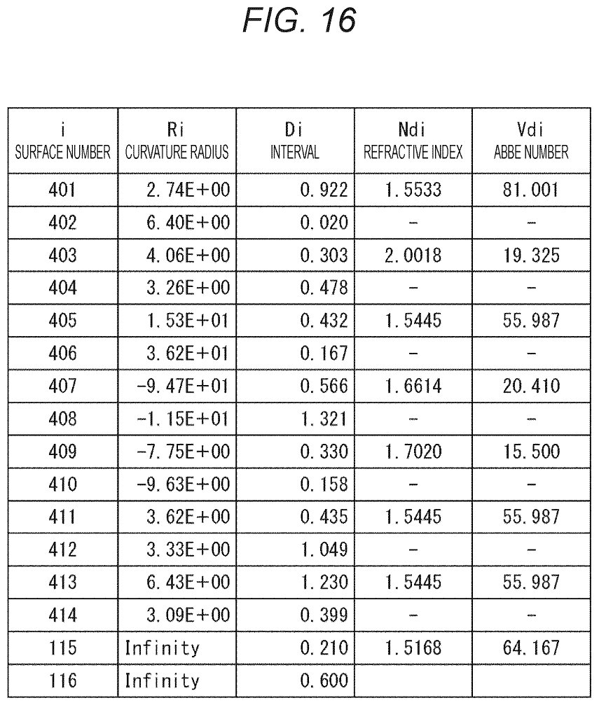

FIG. 16 is a table representing the lens data of the lenses 371 to 377.

Rows in the table of FIG. 16 correspond to the surfaces 371a to 377a, the surfaces 371b to 377b, and the surfaces 78a and 78b, respectively. Columns correspond to a surface number i, a curvature radius Ri, a surface interval Di, a refractive index Ndi with respect to a d line, and an Abbe number Vdi with respect to the d line in order from a left side.

In the present specification, it is assumed that surface numbers having 401 to 414 are sequentially assigned to the surfaces 371a, 371b, 372a, 372b, 373a, 373b, 374a, 374b, 375a, 375b, 376a, 376b, 377a, and 377b. Numerical values in the columns of the table of FIG. 16 refer to FIG. 16.

As illustrated in the table of FIG. 16, among surface intervals D402, D404, D406, D408, D410, and D412 between the facing surfaces of each pair including two adjacent lenses among the lenses 371 to 377, the surface interval D408 is the longest.

### <Fourth Example of Aspherical Data of Each Surface>

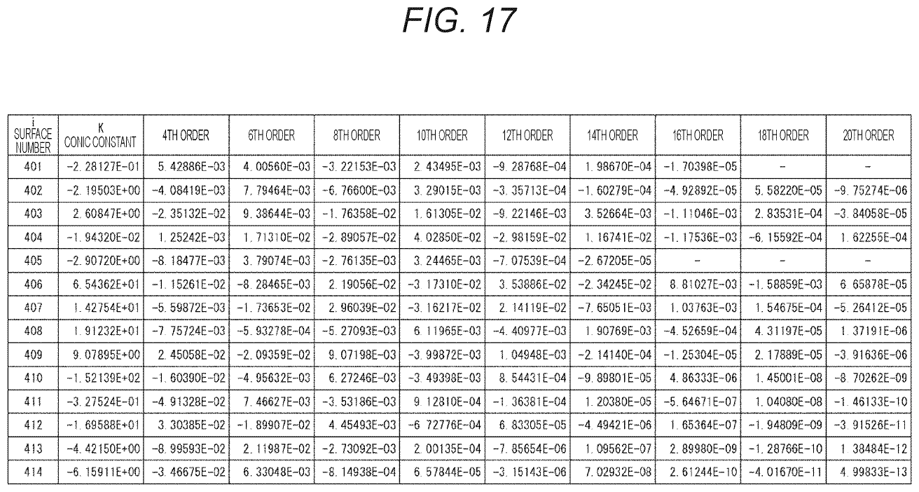

FIG. 17 is a table representing aspherical data of the surfaces 371a to 377a and the surfaces 371b to 377b.

Rows in the table of FIG. 17 correspond to the surfaces 371a to 377a and the surfaces 371b to 377b, respectively. Columns correspond to a surface number i, a conic constant K, a 4th order aspheric coefficient, a 6th order aspheric coefficient, an 8th order aspheric coefficient, a 10th order aspheric coefficient, a 12th order aspheric coefficient, a 14th order aspheric coefficient, a 16th order aspheric coefficient, a 18th order aspheric coefficient, and a 20th order aspheric coefficient in order from a left side. Numerical values in the columns of the table of FIG. 17 refer to FIG. 17.

### <Fourth Example of Spherical Aberration, Field Curvature, and Distortion Aberration>

FIG. 18 is a graph representing a spherical aberration, a field curvature, and a distortion aberration which occur in the lens optical system 25 of FIG. 15.

A of FIG. 18 is a graph representing a spherical aberration in a longitudinal direction for every wavelength of light rays having wavelengths of 443.58 nm, 486.13 nm, 546.07 nm, 587.56 nm, and 656.37 nm, which occur in the lens optical system 25 of FIG. 15. B of FIG. 18 is a graph representing a field curvature which occurs in the lens optical system 25 of FIG. 15. C of FIG. 18 is a graph representing a distortion aberration of the light having the wavelength of 587.56 nm, which occurs in the lens optical system 25 of FIG. 15.

### <Fifth Configuration Example of Lens Optical System>

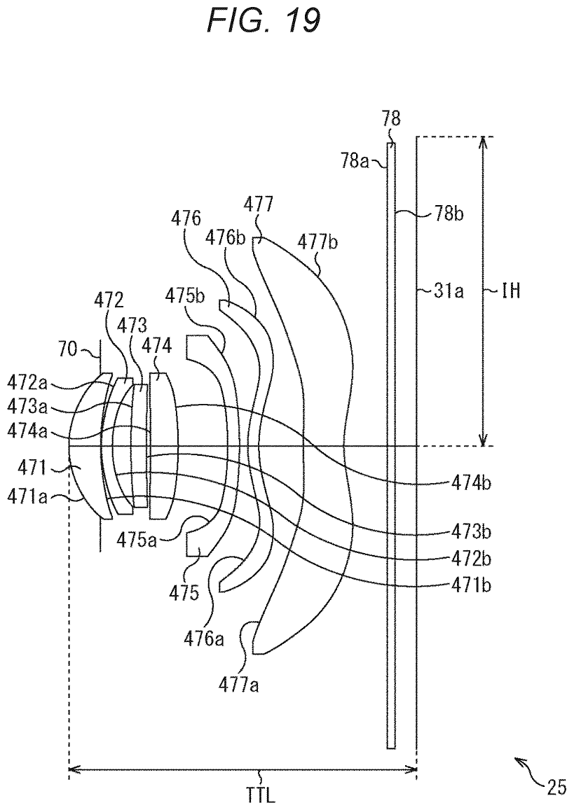

FIG. 19 is a sectional view illustrating a fifth configuration example of the lens optical system 25.

In the lens optical system 25 of FIG. 19, portions corresponding to those of the lens optical system 25 of FIG. 2 are denoted by the same reference signs. Accordingly, the description of the portions will be appropriately omitted, and description will be given focusing on portions different from those of the lens optical system 25 of FIG. 2. The lens optical system 25 of FIG. 19 is different from the lens optical system 25 of FIG. 2 in that the lenses 71 to 77 are replaced with lenses 471 to 477, and has a configuration similar to the lens optical system 25 of FIG. 2 except for this point.

The lenses 471 to 477 are different from the lenses 71 to 77 in that lens data and aspherical data of each surface are different, and have configurations similar to the lenses 71 to 77 except for this point. Accordingly, hereinafter, lens data of the lenses 471 to 477 and aspherical data of surfaces 471a to 477a on the object side and surfaces 471b to 477b on the image side will be described below.

### <Fifth Example of Lens Data of Each Lens>

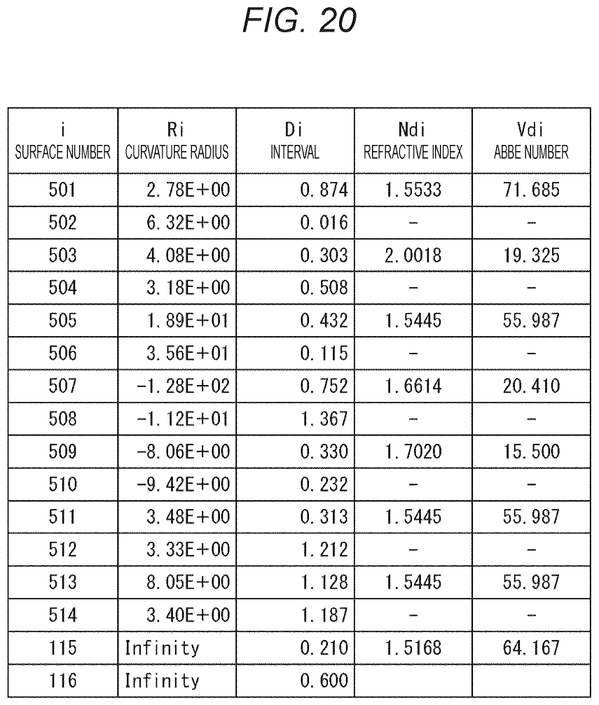

FIG. 20 is a table representing the lens data of the lenses 471 to 477.

Rows in the table of FIG. 20 correspond to the surfaces 471a to 477a, the surfaces 471b to 477b, and the surfaces 78a and 78b, respectively. Columns correspond to a surface number i, a curvature radius Ri, a surface interval Di, a refractive index Ndi with respect to a d line, and an Abbe number Vdi with respect to the d line in order from a left side.

In the present specification, it is assumed that surface numbers having 501 to 514 are sequentially assigned to the surfaces 471a, 471b, 472a, 472b, 473a, 473b, 474a, 474b, 475a, 475b, 476a, 476b, 477a, and 477b. Numerical values in the columns of the table of FIG. 20 refer to FIG. 20.

As illustrated in the table of FIG. 20, among surface intervals D502, D504, D506, D508, D510, and D512 between the facing surfaces of each pair including two adjacent lenses among the lenses 471 to 477, the surface interval D508 is the longest.

### <Fifth Example of Aspherical Data of Each Surface>

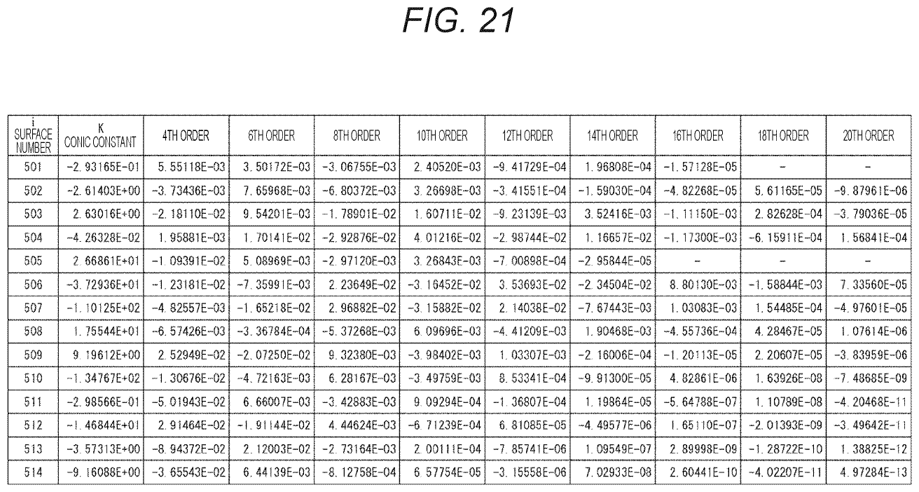

FIG. 21 is a table representing aspherical data of the surfaces 471a to 477a and the surfaces 471b to 477b.

Rows in the table of FIG. 21 correspond to the surfaces 471a to 477a and the surfaces 471b to 477b, respectively. Columns correspond to a surface number i, a conic constant K, a 4th order aspheric coefficient, a 6th order aspheric coefficient, an 8th order aspheric coefficient, a 10th order aspheric coefficient, a 12th order aspheric coefficient, a 14th order aspheric coefficient, a 16th order aspheric coefficient, a 18th order aspheric coefficient, and a 20th order aspheric coefficient in order from a left side. Numerical values in the columns of the table of FIG. 21 refer to FIG. 21.

### <Fifth Example of Spherical Aberration, Field Curvature, and Distortion Aberration>

FIG. 22 is a graph representing a spherical aberration, a field curvature, and a distortion aberration which occur in the lens optical system 25 of FIG. 19.

A of FIG. 22 is a graph representing a spherical aberration for every wavelength of light rays having wavelengths of 443.58 nm, 486.13 nm, 546.07 nm, 587.56 nm, and 656.47 nm, which occurs in the lens optical system 25 of FIG. 19. B of FIG. 22 is a graph representing a field curvature which occurs in the lens optical system 25 of FIG. 19. C of FIG. 22 is a graph representing a distortion aberration of the light having the wavelength of 587.56 nm, which occurs in the lens optical system 25 of FIG. 19.

### <Values of Parameters or Expressions>

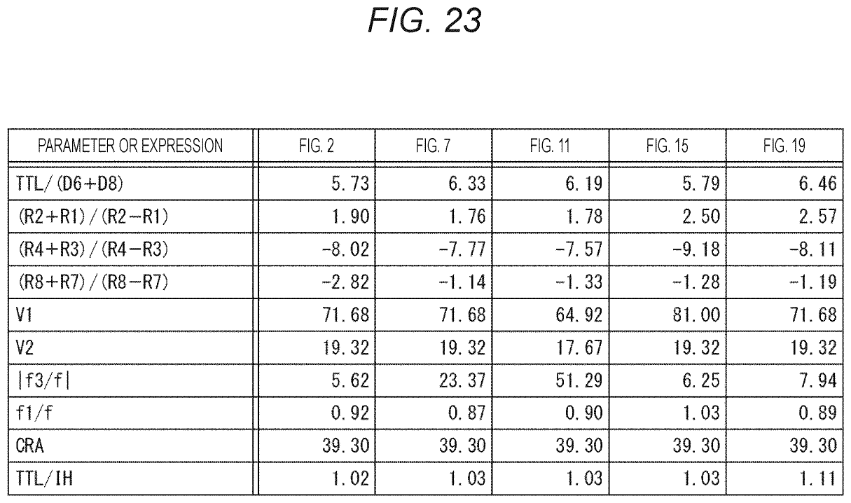

FIG. 23 is a table representing values of parameters or expressions in the lens optical system 25 of FIGS. 2, 7, 11, 15, and 19.

Rows in the table of FIG. 23 correspond to TTL/(D6+D8), (R2+R1)/(R2−R1), (R4+R3)/(R4−R3), (R8+R7)/(R8−R7), v1, v2, |f3/f|, f1/f, CRA, and TTL/IH in order from the top. Columns correspond to the lens optical system 25 of FIGS. 2, 7, 11, 15, and 19 in order from a left side.

Here, D6 is a generic term for a surface interval Dj06 (j=1, 2, 3, 4, and 5), and D8 is a generic term for a surface interval Dj08. R1 to R4 are generic terms for curvature radii Rj01 to Rj04, respectively. R7 and R8 are generic terms for curvature radii Rj07 and Rj08, respectively. V1 and V2 are generic terms for Abbe numbers Vj01 and Vj02, respectively. f is a focal distance of the entire lens optical system 25. f1 is a generic term for focal distances of lenses 71, 171, 271, 371, and 471. f3 is a generic term for focal distances of lenses 73, 173, 273, 373, and 473. CRA is a maximum angle of an angle formed by a principal light ray of the light incident on the imaging surface 31a from the lens optical system 25 and the imaging surface 31a. IH is a distance from a center of the imaging surface 31a to a position where a principal light ray of a light ray having a maximum angle of view reaches, that is, a maximum image height in the lens optical system 25.

As illustrated in FIG. 23, in the lens optical system 25 of FIGS. 2, 7, 11, 15, and 19, TTL/(D6+D8) is 5.73, 6.33, 6.19, 5.79, and 6.46. Accordingly, the lens optical system 25 of FIGS. 2, 7, 11, 15, and 19 satisfies the following Conditional Expression (1).

5.0<TTL/(D6+D8)<10.0 (1 )

In a case where TTL/(D6+D8) exceeds an upper limit of Conditional Expression (1), the total length TTL becomes longer than the interval between the lens 73 (173, 273, 373, or 473) and the lens 75 (175, 275, 375, or 475), and it is difficult to decrease the size of the lens optical system 25. In a case where TTL/(D6+D8) is less than a lower limit of Conditional Expression (1), the total length TTL becomes shorter than the interval between the lens 73 (173, 273, 373, or 473) and the lens 75 (175, 275, 375, or 475). Therefore, it is difficult for the lens 74 (174, 274, 374, or 474) to suitably correct the emission angle of the light ray. As a result, it becomes difficult to increase the size of the solid-state image pickup element 21.

As illustrated in FIG. 23, in the lens optical system 25 of FIGS. 2, 7, 11, 15, and 19, (R2+R1)/(R2−R1) is 1.90, 1.76, 1.78, 2.50, and 2.57. Accordingly, the lens optical system 25 of FIGS. 2, 7, 11, 15, and 19 satisfies the following Conditional Expression (2).

0.5<(R2+R1)/(R2−R1)<3.0 (2 )

In a case where (R2+R1)/(R2−R1) exceeds an upper limit of Conditional Expression (2), a power (refractive power) of the lens 71 (171,271, 371, or 471) becomes weak, and the total length TTL becomes long. Accordingly, it is difficult to decrease the size of the lens optical system 25. In a case where (R2+R1)/(R2−R1) is less than a lower limit of Conditional Expression (2), a power of the lens 71 (171, 271, 371, or 471) becomes strong, and a spherical aberration deteriorates.

As illustrated in FIG. 23, in the lens optical system 25 of FIGS. 2, 7, 11, 15, and 19, (R4+R3)/(R4−R3) is −8.02, −7.77, −7.57, −9.18, and −8.11. Accordingly, the lens optical system 25 of FIGS. 2, 7, 11, 15, and 19 satisfies the following Conditional Expression (3).

−10.0<(R4+R3)/(R4−R3)<−3.0 (3)

In a case where (R4+R3)/(R4−R3) exceeds an upper limit of Conditional Expression (3), a power of the lens 72 (172, 272, 372, or 472) becomes strong, and it is difficult to correct a spherical aberration. In a case where (R4+R3)/(R4−R3) is less than a lower limit of Conditional Expression (3), since a power of the lens 72 (172, 272, 372, or 472) becomes weak, the total length TTL becomes long, and it is difficult to decrease the size of the lens optical system 25.

As illustrated in FIG. 23, in the lens optical system 25 of FIGS. 2, 7, 11, 15, and 19, (R8 +R7)/(R8−R7) is −2.82, −1.14, −1.33, −1.28, and −1.19. Accordingly, the lens optical system 25 of FIGS. 2, 7, 11, 15, and 19 satisfies the following Conditional Expression (4).

−10.0<(R8+R7)/(R8−R7)<−1.0 (4)

In a case where (R8+R7)/(R8−R7) exceeds an upper limit of Conditional Expression (4), a power of the lens 72 (172, 272, 372, or 472) becomes strong, and it is difficult to correct a coma aberration and an astigmatism. In a case where (R8+R7)/(R8−R7) is less than a lower limit of Conditional Expression (4), since a power of the lens 72 (172, 272, 372, or 472) becomes looser (weak) and the emission angle of the light ray with respect to the optical axis, it is difficult to increase the size of the solid-state image pickup element 21.

As illustrated in FIG. 23, in the lens optical system 25 of FIGS. 2, 7, 11, 15, and 19, the Abbe number V1 is 71.68, 71.68, 64.92, 81.00, 71.68. Accordingly, the lens optical system 25 of FIGS. 2, 7, 11, 15, and 19 satisfies the following Conditional Expression (5).

50.0<V1 <90.0 (5 )

In a case where V1 exceeds an upper limit of Conditional Expression (5), since a refractive index of the lens 71 (171, 271, 371, or 471) is low, it is difficult to correct a spherical aberration. In a case where V1 is less than a lower limit of Conditional Expression (5), it is difficult to correct an axial chromatic aberration.

As illustrated in FIG. 23, in the lens optical system 25 of FIGS. 2, 7, 11, 15, and 19, V2 is 19.32, 19.32, 17.67, 19.32, and 19.32. Accordingly, the lens optical system 25 of FIGS. 2, 7, 11, 15, and 19 satisfies the following Conditional Expression (6).

15.0<V2<20.0 (6 )

In a case where V2 exceeds an upper limit of Conditional Expression (6), since a refractive index of the lens 72 (172, 272, 372, or 472) is low, it is difficult to correct a spherical aberration. In a case where V2 is less than a lower limit of Conditional Expression (6), it is difficult to correct an axial chromatic aberration.

As illustrated in FIG. 23, in the lens optical system 25 of FIGS. 2, 7, 11, 15, and 19, |f3/f| is 5.62, 23.37, 51.29, 6.25, and 7.94. Accordingly, the lens optical system 25 of FIGS. 2, 7, 11, 15, and 19 satisfies the following Conditional Expression (7).

5<|f3/f|<100.0 (7 )

In a case where |f3/f| exceeds an upper limit of Conditional Expression (7), since a focal distance f3 is long, it is difficult to correct the emission angle of the light ray. In a case where |f3/f| is less than a lower limit of Conditional Expression (7), since the focal distance f3 is short, it is difficult to correct various aberrations.

As illustrated in FIG. 23, in the lens optical system 25 of FIGS. 2, 7, 11, 15, and 19, f1/f is 0.92, 0.87, 0.90, 1.03, and 0.89. Accordingly, the lens optical system 25 of FIGS. 2, 7, 11, 15, and 19 satisfies the following Conditional Expression (8).

0<F1/f<2.0 (8 )

In a case where f1/f exceeds an upper limit of Conditional Expression (8), since the focal distance f1 is long, it is difficult to correct a spherical aberration.

As illustrated in FIG. 23, in the lens optical system 25 of FIGS. 2, 7, 11, 15, and 19, CRA is 39.30. Accordingly, the lens optical system 25 of FIGS. 2, 7, 11, 15, and 19 satisfies the following Conditional Expression (9).

CRA<40.0 (9)

In a case where CRA exceeds an upper limit of Conditional Expression (9), an angle of the light ray incident on the imaging surface 31a increases, and conversion efficiency of the solid-state image pickup element 21 decreases.

As illustrated in FIG. 23, in the lens optical system 25 of FIGS. 2, 7, 11, 15, and 19, TTL/IH is 1.02, 1.03, 1.03, 1.03, and 1.11. Accordingly, the lens optical system 25 of FIGS. 2, 7, 11, 15, and 19 satisfies the following Conditional Expression (10).

1.0<TTL/IH<1.3 (10 )

In a case where TTL/IH exceeds an upper limit of Conditional Expression (10), the total length TTL of the lens optical system 25 with respect to the solid-state image pickup element 21 becomes long, and it is difficult to decrease the size of the lens optical system 25 and eventually the size of the imaging apparatus 10. In a case where TTL/IH is less than a lower limit of Conditional Expression (10), it is difficult to correct various aberrations.

As described above, the lens optical system 25 includes the lens 71 (171, 271, 371, or 471) to the lens 77 (177, 277, 377, or 477) in order from the object side to the image side. The lens 71 (171, 271, 371, or 471) has a positive refractive power near the optical axis and has a meniscus shape convex toward the object side. The lens 72 (172, 272, 372, or 472) has a negative refractive power near the optical axis and has a meniscus shape convex toward the object side. The lens 73 (173, 273, 373, or 473) has a refractive power near the optical axis. The lens 74 (174, 274, 374, or 474) has a positive refractive power near the optical axis and has a meniscus shape convex toward the image side. The lens 75 (175, 275, 375, or 475) has a refractive power near the optical axis and has a meniscus shape convex toward the image side. The lens 76 (176, 276, 376, or 476) has a refractive power near the optical axis and has a meniscus shape convex toward the object side. The lens 77 (177, 277, 377, or 477) has a negative refractive power near the optical axis and has a meniscus shape convex toward the object side. Among the surface intervals between the facing surfaces of each pair including two adjacent lenses among the lenses 71 (171, 271, 371, or 471) to the lenses 77 (177, 277, 377, or 477), the surface interval D108 (D208, D308, D408, or D508) is the longest.

Accordingly, it is possible to realize the lens optical system 25 with high optical performance corresponding to the large-sized and high-pixel solid-state image pickup element 21. Furthermore, since the lens optical system 25 satisfies Conditional Expression (10), it is possible to decrease the size of the lens optical system 25, eventually the size of the imaging apparatus 10.

It is to be noted that the numerical values of the lens data and the aspherical data in the lens optical system 25 are not limited to the above-described numerical values.

### 2. Application Example to Electronic Device

The imaging apparatus 10 described above can be applied to various kinds of electronic devices such as, for example, a digital still camera, a digital video camera, a mobile phone having an imaging function, and a mobile device such as a smartphone.

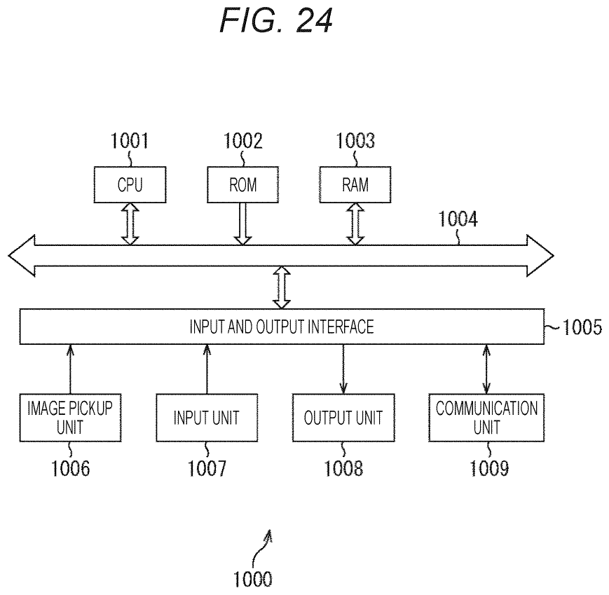

FIG. 24 is a block diagram illustrating a hardware configuration example of a smartphone as an electronic device to which the present technology is provided.

In a smartphone 1000, a central processing unit (CPU) 1001, a read only memory (ROM) 1002, and a random access memory (RAM) 1003 are mutually connected via a bus 1004.

An input and output interface 1005 is further connected to the bus 1004. An image pickup unit 1006, an input unit 1007, an output unit 1008, and a communication unit 1009 are connected to the input and output interface 1005.

The image pickup unit 1006 includes the above-described imaging apparatus 10 and the like. The image pickup unit 1006 images a subject and acquires an image. This image is stored in the RAM 1003 or displayed on the output unit 1008. The input unit 1007 includes a touch pad which is a position input apparatus constituting a touch panel, a microphone, and the like. The output unit 1008 includes a liquid crystal panel constituting a touch panel, a speaker, and the like. The communication unit 1009 includes a network interface or the like.

In the smartphone 1000 having the above-described configuration, the imaging apparatus 10 is applied as the image pickup unit 1006, and thus, it is also possible to realize high optical performance corresponding to the large-sized and high-pixel solid-state image pickup element 21 in the lens optical system 25. As a result, the smartphone 1000 can image a high-quality image with high pixels.

### 3. Usage Example of Imaging Apparatus

FIG. 25 is a diagram illustrating a usage example in which the above-described imaging apparatus 10 is used.

The above-described imaging apparatus 10 can be used, for example, in various cases where light such as visible light, infrared light, ultraviolet light, and X-rays is sensed as will be described below. ·Apparatus that images an image, provided for viewing purposes, such as a digital camera and a portable device with a camera function
Apparatus provided for traffic purpose such as an in-vehicle sensor that images the front, rear, surroundings, interior, and the like of an automobile, a monitoring camera for monitoring traveling vehicles and roads, and a ranging sensor that measures a distance between vehicles and the like for safe driving such as automatic stop, recognition of a driver's condition, and the like
Apparatus provided for home appliance such as a television, a refrigerator, and an air conditioner that images a user's gesture and performs a device operation according to the gesture
Apparatus provided for medical and health care such as an endoscope and an apparatus that performs angiography by receiving infrared light
Apparatus provided for security such as a security monitoring camera and an individual authentication camera
Apparatus provided for beauty care such as a skin measuring instrument for imaging skin and a microscope for imaging the scalp
Apparatus provided for sport such as an action camera or a wearable camera for sports applications or the like
Apparatus provided for agricultural purposes, such as a camera for monitoring conditions of fields and crops

### 4. Application Example to Endoscopic Surgery System

The technology according to the present disclosure (present technology) can be applied to various kinds of products. For example, the technology according to the present disclosure may be applied to an endoscopic surgery system.

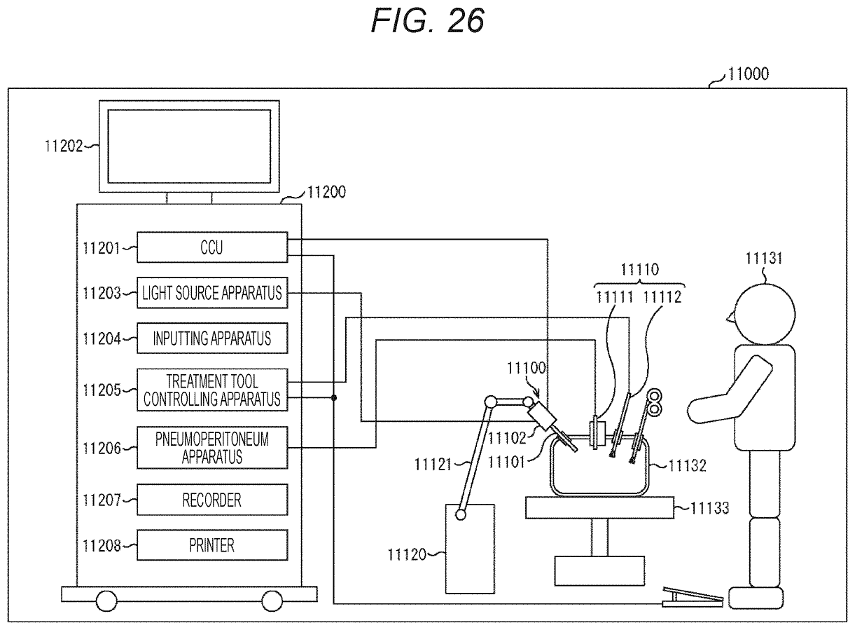

FIG. 26 is a diagram illustrating an example of a schematic configuration of the endoscopic surgery system to which the technology of the present disclosure (present technology) can be applied.

FIG. 26 illustrates a scene in which a surgeon (medical doctor) 11131 is performing surgery for a patient 11132 on a patient bed 11133 by using an endoscopic surgery system 11000. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example depicted, the endoscope 11100 is depicted which includes as a rigid endoscope having the lens barrel 11101 of the hard type. However, the endoscope 11100 may otherwise be included as a flexible endoscope having the lens barrel 11101 of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 is a light source such as a light emitting diode (LED), for example, and supplies irradiation light for imaging a surgical region or the like to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

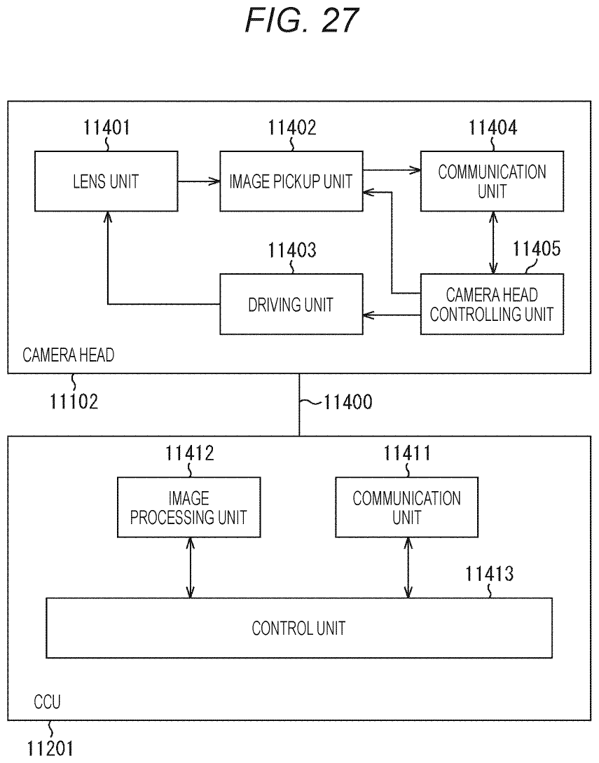

FIG. 27 is a block diagram illustrating an example of a functional configuration of the camera head 11102 and the CCU 11201 illustrated in FIG. 26.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The image pickup unit 11402 includes an image pickup element. The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. Alternatively, the image pickup unit 11402 may include a pair of image pickup elements for acquiring right-eye and left-eye image signals compatible with three-dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

An example of the endoscopic surgery system to which the technology according to the present disclosure can be applied has been described above. The technology according to the present disclosure can be applied to the lens unit 11401, the image pickup unit 11402, and the like among the above-described configurations. Specifically, the imaging apparatus 10 described above can be applied to the lens unit 11401, the image pickup unit 11402, and the driving unit 11403. The technology according to the present disclosure is applied to the lens unit 11401 and the image pickup unit 11402, and thus, it is possible to realize high optical performance corresponding to the large-sized and high-pixel solid-state image pickup element 21 in the lens optical system 25. As a result, for example, the surgeon can reliably confirm the surgical region by a high-quality surgical site image with high pixels.

It is to be noted that the endoscopic surgery system has been described as an example herein, but in addition, the technology according to the present disclosure may be applied to a microscopic surgery system or the like, for example.

### 5. Application Example to Moving Body

The technology according to the present disclosure (present technology) can be applied to various kinds of products. For example, the technology according to the present disclosure may be realized as an apparatus included in any kind of moving body such as an automobile, an electric vehicle, a hybrid electric vehicle, a motorcycle, a bicycle, a personal mobility, an airplane, a drone, a ship, a robot, and the like.

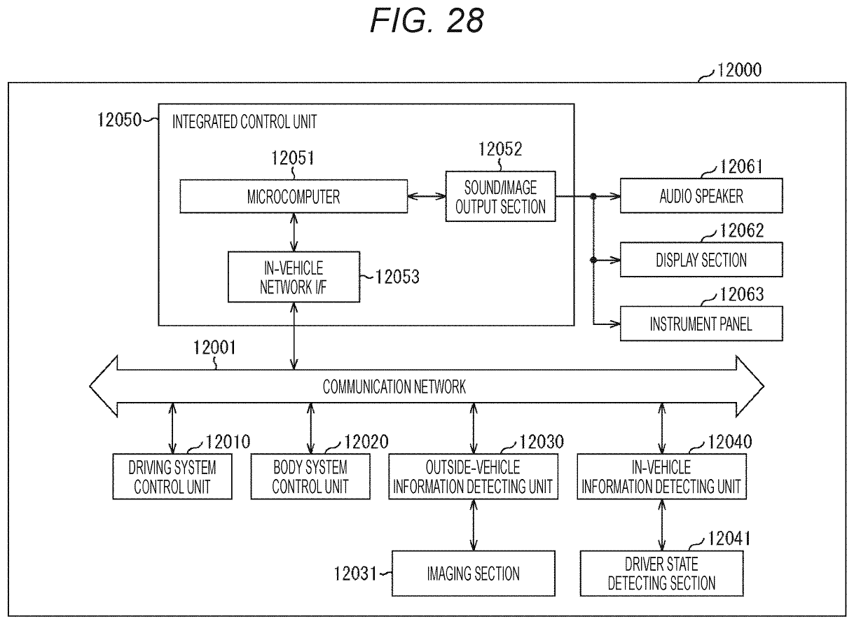

FIG. 28 is a block diagram illustrating a schematic configuration example of a vehicle control system as an example of a moving body control system to which the technology according to the present disclosure can be applied.

The vehicle control system 12000 includes a plurality of electronic control units connected to each other via a communication network 12001. In the example illustrated in FIG. 28, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and an in-vehicle network interface (I/F) 12053 are illustrated as functional configurations of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 28, as the output device, an audio speaker 12061, a display section 12062, and an instrument panel 12063 are illustrated. The display section 12062 may, for example, include at least one of an on-board display and a head-up display.

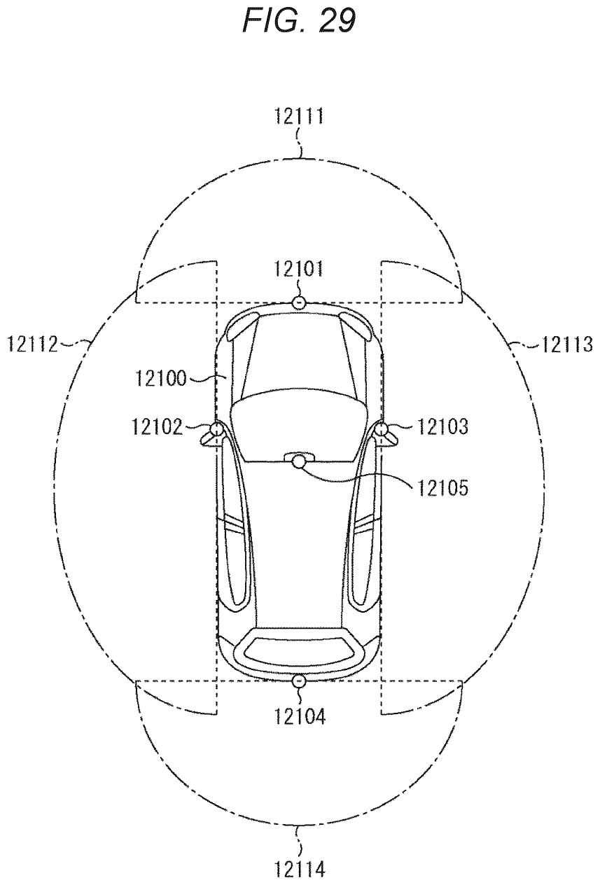

FIG. 29 is a diagram illustrating an example of an installation position of the imaging section 12031.

In FIG. 29, a vehicle 12100 includes imaging sections 12101, 12102, 12103, 12104, and 12105 as the imaging section 12031.

The imaging sections 12101, 12102, 12103, 12104, and 12105 are provided at, for example, positions such as a front nose, a sideview mirror, a rear bumper, a back door, an upper portion of a windshield within the interior of the vehicle 12100, and the like. The imaging section 12101 provided to the front nose and the imaging section 12105 provided to the upper portion of the windshield within the interior of the vehicle obtain mainly an image of the front of the vehicle 12100. The imaging sections 12102 and 12103 provided at the sideview mirrors obtain mainly images of sides of the vehicle 12100. The imaging section 12104 provided to the rear bumper or the back door obtains mainly an image of the rear of the vehicle 12100. Images of the front to be obtained by the imaging sections 12101 and 12105 are used mainly to detect a preceding vehicle, a pedestrian, an obstacle, a traffic signal, a traffic sign, a lane, or the like.

It is to be noted that FIG. 29 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 and the like in the configuration described above. Specifically, the imaging apparatus 10 described above can be applied to the imaging section 12031. The technology according to the present disclosure is applied to the imaging section 12031, and thus, it is possible to realize high optical performance corresponding to the large-sized and high-pixel solid-state image pickup element 21 in the lens optical system 25. As a result, it is possible to reduce driver's fatigue, for example, by an imaged image with high pixels and high image quality.

The embodiment of the present technology is not limited to the embodiment described above, and various modifications can be made without departing from the scope of the present technology. For example, the number and position of inflection points of each surface, lens data of each lens, aspherical data of each surface, and a tangential angle of a peripheral portion of a lens effective diameter are not limited to the above-described examples. It is also possible to adopt a mode in which all or some of the plurality of embodiments described above are combined.

The effects described in the present specification are merely examples and are not limited, and there may be other effects.

The present technology can have the following configurations.

(1)

A lens optical system including:
in order from an object side to an image side,
a first lens having a positive refractive power near an optical axis and having a meniscus shape convex toward the object side;
a second lens having a negative refractive power near the optical axis and having a meniscus shape convex toward the object side;
a third lens having a refractive power near the optical axis;
a fourth lens having a positive refractive power near the optical axis and having a meniscus shape convex toward the image side;
a fifth lens having a refractive power near the optical axis and having a meniscus shape convex toward the image side,
a sixth lens having a refractive power near the optical axis and having a meniscus shape convex toward the object side, and;
a seventh lens having a negative refractive power near the optical axis and having a meniscus shape convex toward the object side,
in which, among air intervals on an optical axis between facing surfaces of each pair including two adjacent lenses among the first lens to the seventh lens, the interval between the pair including the fourth lens and the fifth lens is the longest.
   (2)

The lens optical system according to the above (1),
in which, when a total length of the lens optical system is TTL, the interval of the pair including the third lens and the fourth lens is D6, and the interval of the pair including the fourth lens and the fifth lens is D8,
a condition of 5.0<TTL/(D6+D8)<10.0 is satisfied.
   (3)

The lens optical system according to the above (1) or (2),
in which, when a curvature radius of a surface of the first lens on the object side is R1 and a curvature radius of a surface of the first lens on the image side is R2,
a condition of 0.5<(R2+R1)/(R2−R1)<3.0 is satisfied.
   (4)

The lens optical system according to any one of the above (1) to (3),
in which, when a curvature radius of a surface of the second lens on the object side is R3 and a curvature radius of a surface of the second lens on the image side is R4,
a condition of −10.0<(R4+R3)/(R4−R3)<−3.0 is satisfied.
   (5)

The lens optical system according to any one of the above (1) to (4),
in which, when a curvature radius of a surface of the fourth lens on the object side is R7 and a curvature radius of a surface of the fourth lens on the image side is R8,
a condition of −10.0<(R8 +R7)/(R8−R7)<−1.0 is satisfied.
   (6)

The lens optical system according to any one of the above (1) to (5),
in which, when an Abbe number of the first lens at a d-line is V1,
a condition of 50.0<V1<90.0 is satisfied.
   (7)

The lens optical system according to any one of the above (1) to (6),
in which, when an Abbe number of the second lens at a d-line is V2,
a condition of 15.0<V2<20.0 is satisfied.
   (8)

The lens optical system according to any one of the above (1) to (7),
in which, when a focal distance of the third lens is f3 and a focal distance of the lens optical system is f,
a condition of 5<|f3/f|<100.0 is satisfied.
   (9)

The lens optical system according to any one of the above (1) to (8),
in which, when a focal distance of the first lens is f1 and a focal distance of the lens optical system is f,
a condition of 0<f1/f<2.0 is satisfied.
   (10)

### The Lens Optical System According to Any One of the Above

(1) to (9), in which, when a maximum angle formed by a principal light ray of light incident on an imaging surface from the lens optical system and the imaging surface is CRA, a condition of CRA<40.0 is satisfied. (11)

The lens optical system according to any one of the above (1) to (10),
in which, when a total length of the lens optical system is TTL and a maximum image height in the lens optical system is IH,
a condition of 1.0<TTL/IH<1.3 is satisfied.
   (12)

An imaging apparatus comprising:
a lens optical system that includes,
in order from an object side to an image side,
a first lens having a positive refractive power near an optical axis and having a meniscus shape convex toward the object side,
a second lens having a negative refractive power near the optical axis and having a meniscus shape convex toward the object side,
a third lens having a refractive power near the optical axis,
a fourth lens having a positive refractive power near the optical axis and having a meniscus shape convex toward the image side,
a fifth lens having a refractive power near the optical axis and having a meniscus shape convex toward the image side,
a sixth lens having a refractive power near the optical axis and having a meniscus shape convex toward the object side, and
a seventh lens having a negative refractive power near the optical axis and having a meniscus shape convex toward the object side, among air intervals on an optical axis between facing surfaces of each pair including two adjacent lenses among the first lens to the seventh lens, the interval between a pair including the fourth lens and the fifth lens being the longest; and
an image pickup element that converts an optical image formed by the lens optical system into an electric signal.

### REFERENCE SIGNS LIST

10 Imaging apparatus
21 Solid-state image pickup element
25 Lens optical system
31a Imaging surface
71 to 77 Lens
71a, 71b, 72a, 72b, 73a, 73b, 74a, 74b, 75a, 75b, 76a, 76b, 77a Surface
171 to 177 Lens
171a, 171b, 172a, 172b, 173a, 173b, 174a, 174b, 175a, 175b, 176a, 176b, 177a Surface
271 to 277 Lens
271a, 271b, 272a, 272b, 273a, 273b, 274a, 274b, 275a, 275b, 276a, 276b, 277a Surface
371 to 377 Lens
371a, 371b, 372a, 372b, 373a, 373b, 374a, 374b, 375a, 375b, 376a, 376b, 377a Surface
471 to 477 Lens
471a, 471b, 472a, 472b, 473a, 473b, 474a, 474b, 475a, 475b, 476a, 476b, 477a Surface

1. A lens optical system comprising:
in order from an object side to an image side,
a first lens having a positive refractive power near an optical axis and having a meniscus shape convex toward the object side;
a second lens having a negative refractive power near the optical axis and having a meniscus shape convex toward the object side;
a third lens having a refractive power near the optical axis;
a fourth lens having a positive refractive power near the optical axis and having a meniscus shape convex toward the image side;
a fifth lens having a refractive power near the optical axis and having a meniscus shape convex toward the image side;
a sixth lens having a refractive power near the optical axis and having a meniscus shape convex toward the object side; and
a seventh lens having a negative refractive power near the optical axis and having a meniscus shape convex toward the object side,
wherein, among air intervals on an optical axis between facing surfaces of each pair including two adjacent lenses among the first lens to the seventh lens, the interval between the pair including the fourth lens and the fifth lens is the longest.

2. The lens optical system according to claim 1,
wherein, when a total length of the lens optical system is TTL, the interval of the pair including the third lens and the fourth lens is D6, and the interval of the pair including the fourth lens and the fifth lens is D8,
a condition of 5.0<TTL/(D6+D8)<10.0 is satisfied.

3. The lens optical system according to claim 1,
wherein, when a curvature radius of a surface of the first lens on the object side is R1 and a curvature radius of a surface of the first lens on the image side is R2,
a condition of 0.5<(R2+R1)/(R2−R1)<3.0 is satisfied.

4. The lens optical system according to claim 1,
wherein, when a curvature radius of a surface of the second lens on the object side is R3 and a curvature radius of a surface of the second lens on the image side is R4,
a condition of −10.0<(R4+R3)/(R4−R3)<−3.0 is satisfied.

5. The lens optical system according to claim 1,
wherein, when a curvature radius of a surface of the fourth lens on the object side is R7 and a curvature radius of a surface of the fourth lens on the image side is R8,
a condition of −10.0<(R8+R7)/(R8−R7)<−1.0 is satisfied.

6. The lens optical system according to claim 1,
wherein, when an Abbe number of the first lens at a d-line is V1,
a condition of 50.0<V1<90.0 is satisfied.

7. The lens optical system according to claim 1,
wherein, when an Abbe number of the second lens at a d-line is V2,
a condition of 15.0<V2<20.0 is satisfied.

8. The lens optical system according to claim 1,
wherein, when a focal distance of the third lens is f3 and a focal distance of the lens optical system is f,
a condition of 5<|f3/f|<100.0 is satisfied.

9. The lens optical system according to claim 1,
wherein, when a focal distance of the first lens is f1 and a focal distance of the lens optical system is f,
a condition of 0<f1/f<2.0 is satisfied.

10. The lens optical system according to claim 1,
wherein, when a maximum angle formed by a principal light ray of light incident on an imaging surface from the lens optical system and the imaging surface is CRA,
a condition of CRA<40.0 is satisfied.

11. The lens optical system according to claim 1,
wherein, when a total length of the lens optical system is TTL and a maximum image height in the lens optical system is IH,
a condition of 1.0<TTL/IH<1.3 is satisfied.

12. An imaging apparatus comprising:
a lens optical system that includes,
in order from an object side to an image side,
a first lens having a positive refractive power near an optical axis and having a meniscus shape convex toward the object side,
a second lens having a negative refractive power near the optical axis and having a meniscus shape convex toward the object side,
a third lens having a refractive power near the optical axis,
a fourth lens having a positive refractive power near the optical axis and having a meniscus shape convex toward the image side,
a fifth lens having a refractive power near the optical axis and having a meniscus shape convex toward the image side,
a sixth lens having a refractive power near the optical axis and having a meniscus shape convex toward the object side, and
a seventh lens having a negative refractive power near the optical axis and having a meniscus shape convex toward the object side, among air intervals on an optical axis between facing surfaces of each pair including two adjacent lenses among the first lens to the seventh lens, the interval between a pair including the fourth lens and the fifth lens being the longest; and
an image pickup element that converts an optical image formed by the lens optical system into an electric signal.
